(19) United States
(12) Patent Application Publication
(10) Pub. No.: US 2010/0131455 A1
(43) Pub. Date: May 27, 2010

(54) CROSS-WEBSITE MANAGEMENT INFORMATION SYSTEM

(76) Inventors: James D. Logan, Candia, NH (US); Michael Bartman, Potomac, MD (US)

Correspondence Address: LOGINOV & ASSOCIATES, PLLC, 10 WATER STREET, CONCORD, NH, 03301, US

(21) Appl. No.: 12/273,543

(22) Filed: Nov. 19, 2008

(51) Int. Cl. G06F 17/30; G06F 7/00

(52) U.S. Cl. 707/602; 707/E17.005

(57) ABSTRACT

Methods, systems, apparatus, and software for providing information from one or more data feeds to a user are provided. In some embodiments, the methods provided by the invention include obtaining at least one putative feed; confirming that the putative feed is a feed; extracting at least a portion of content from the feed or data related to the content from the feed; processing the extracted content or the data to produce a synthetic feed; and presenting the synthetic feed to the user. In more specific embodiments, the putative fee is selected from the group consisting of: RSS feeds and Web syndication feeds. In still more specific embodiments, the portion of the content or data related to the content is selected from the group consisting of: blog posts, podcasts, videos, and Web pages.

### NOTICE OF COPYRIGHT

Portions of this patent application include materials that are subject to copyright protection. The copyright owner has no objection to the facsimile reproduction by anyone of the patent document itself, or of the patent application, as it appears in the files of the United States Patent and Trademark Office, but otherwise reserves all copyright rights whatsoever in such included copyrighted materials. The following notice shall apply to this document: Copyright 2008, InfoTuit, Inc.

### BACKGROUND OF THE INVENTION

1. Field of the Invention

The present invention relates to methods, software, systems, and apparatus for providing information to a user, and more particularly information derived from multiple sources, such as Web blogs, RSS feeds, blogrolls, and similar and related data, and presenting such information in a useful manner to the user. The technology herein has applications in the areas of information theory, computer science, and computer networks.

2. The Related Art

The ready access to the Internet has led to an explosion of new technologies and methods of conveying information, organizing social structures, conducting business, and finding information, products, and other things, for computer users. One of the most commonly used Internet features is the World Wide Web (“the Web”). The Web includes a large number of servers (“Web servers”) that provide information, usually formatted as “Web pages”, that users accessing various kinds of client programs (“Web browsers”). Web pages can include a variety of content types, such as text, images, sounds, video and audio data, documents, software programs and devices, and links to other Web pages or content having a similar variety of data types.

One type of software device commonly associated with Web pages is referred to as a “Web widget”, or just a “widget”. A Web widget is a portable software device that can be linked to and executed as part of a Hyper Text Markup Language or Extensible HyperText Markup Language-based (“HTML” or “XHTML”) Web page without requiring additional compilation. Web widgets execute within a Web browser and, for security reasons, often have limitations placed on their activities by the execution environment provided to them, such as being prevented from contacting Websites other than the one they were obtained from, being prevented from access to the local file system, or being limited to particular file directories in the local file system. Widgets can be used for diverse purposes, such as games, stock tickers, video and audio players, polls, slideshows, mortgage calculators, or other tools. Other terms used to describe Web widgets include “gadget”, “applet”, “badge”, “module”, “capsule”, “snippet”, “mini” and “flake”. Web widgets often, but not always, employ JavaScript, Java, or Adobe Flash for their implementation.

The invention of the World Wide Web (“the Web”), and its subsequent adoption by most Internet users as a way to locate and access information, has also led to the widespread publication of Web-logs (“blogs”) by computer users. “Blogging” as such publication is commonly referred to, is the creation and maintenance of a “blog”. A “blog” is a Website with regularly updated commentary, essays, descriptions of events, or other material such as graphics or video, often similar to an on-line public diary or magazine column. Blogs frequently specialize on a particular topic of interest; and entries are commonly displayed in reverse chronological order, with the newest entries at the top of the list. A typical blog combines text, images, and links to other blogs, Web pages, or other media related to its topic, collectively called “blog content”. A capability for readers to leave comments in an interactive format is an important part of many blogs; such comments are collectively called “blog comments”.

Some blog content is made available using content syndication protocols, such as Atom or RSS. Syndicated content is commonly referred to as a “feed”, “Web feed”, or “channel” and includes a collection of content summaries and links to the actual content on the source Website. Alternatively, the syndicated content can further include copies of the content itself, often presented in a standardized format. The content can be from a particular Website, a particular story or news article, a particular blog entry, user generated content, or it can be some other form of content. Syndication of content in feeds simplifies the user's task of tracking changes across one or several Websites, such as newly added posts in a blog, changes to content items of a news feed, addition of Web pages, and so on. By automating the identification of changed Web sites in a manner that can be used by particular programs, such as RSS Readers, or by filtered displays, such as Web pages that display selected feed content. Common examples of syndication formats include the Atom Syndication Format is an eXtended Markup Language (XML) standard used for Web feeds, while the Atom Publishing Protocol (APP) is a HyperText Transfer Protocol-based (HTTP) protocol for creating and updating Web resources. The term “RSS” is used to refer to any of several generations of standards, and can be used to refer to “Really Simple Syndication (RSS 2.00)”, “RDF Site Summary (RSS 1.00 and RSS 00.900)” or “Rich Site Summary (RSS 00.91)”. RSS is used to publish frequently updated content, such as blog entries, news headlines, and podcasts, in a standardized format based on XML.

As used herein, a “feed” is content in the form of a document, e.g., an XML document, that includes items formatted according to well-known practices that permit individual items to be recognized and used for the purpose of syndicating content for distribution. Typical contents includes or is linked to: Websites, specific parts of Websites, podcasts, images, videos or other text or media content, software, or other feeds. Feeds can also include descriptive information that identifies content items (e.g., a title, name, or universal ID), describes content items (e.g., a short summary, an initial portion of the item or the complete item itself, tags that permit grouping similar items in several ways), permits the full content associated with items to be located (e.g., URLs), or other item data or meta-data as required or permitted by the format used.

Feeds can be acquired or distributed through network servers such as Websites, by sending them in e-mail, or by other means known commonly among those having ordinary skill in the art. A typical method of distribution includes providing a URL that specifies the feed document's location. Feeds, or links to feeds, are often embedded in Web pages, attached to e-mail or otherwise mixed with other types of data. No special Web page structures delimit feeds or feed links. It is the intended use of the URLs, XML documents or other feed forms that makes them unique, not their particular data structure. Being able to recognize the presence of a feed and to access the feed's items is a necessary capability for use of such embedded feeds, and such recognition is typically left as a manual operation for a user. Users recognize feeds from associated text, commonly used icons, or through trial and error. A method for locating embedded feeds automatically is needed to make efficient use of both the feed data and the user's time.

Feeds can be viewed using software referred to herein as “Readers”. These are sometimes referred to elsewhere as “RSS Readers”, “Feed Readers” or “aggregators” and can generally make use of one or more feed formats (e.g., RSS, or Atom), Readers can be implemented as interactive Web pages or widgets (e.g., Grazr, from Grazr Corp. of Lexington, Mass. or Spotback, from Spotback Ltd.), Web services (e.g., BlogLines, from Bloglines of Campbell, Calif.), Web browser plugins (e.g., BlogRovr, from Activeweave, Inc.), or standalone applications (e.g., FeedDemon, from NewsGator Technologies of Denver, Colo.).

Many Websites, especially blogs, include a list of other Websites that the maintainer of the Website believes will be of interest to visitors. Such lists are referred to by various terms, such as “site lists”, “related links”, “links of interest”, or, often when they appear on blog Websites, as “blogrolls”. These types of lists are referred to herein as “blogrolls” regardless of the type of Website they appear on. There is no current universal standard for how a blogroll is identified, organized, or constructed, though most are associated with one or more of a short list of characteristic words or phrases, such as “blogroll”, “related links”, or “other links of interest”, and include one or more URLs linking to other blogs, Web pages, or portions thereof. While there is no universal standard for the format of a blogroll, a commonly used format for making blogroll data available is Outline Processor Markup Language (“OPML”). OPML is an XML format originally developed by UserLand Software of Danville, Calif. as a native file format for an outliner application, but OPML has since been adopted for other uses, such as to exchange blogrolls. A typical OPML entry for a Website or other blogroll item includes the name of the item and a URL address for the item's feed process.

FIG. 1 depicts a schematic diagram of a typical relationship between posts of various types, RSS feeds, Blogs, Blogrolls, and Web browsers or Readers in the prior art. In the exemplary diagram of FIG. 1, a Web browser or Reader (1310) is used to connect (1490) with a Blog Website (1210), which contains a Blogroll (1215). The Blogroll (1215) lists (1470) URL addresses for a set of RSS feeds (1110, 1120, and 1130). The first RSS Feed (1110) includes or links to (1410 and 1420) two items: a text article (1010) and a Podcast (1020). The second RSS Feed (1120) includes or links to (1430, 1440 and 1450) three items: the same Podcast (1020) as the first RSS Feed (1110), a Video presentation (1030), and some other media (1040). The third RSS Feed (1130) includes or links to (1460) a single item: the same other media (1040) as the second RSS Feed (1120). Items can include text, (X)HTML or other Web page content (1010), audio “Podcasts” (1020), video presentations (1030), or other media (1040).

The same Web browser or Reader (1310) can, at a future time (shown by the dashed lines), be used to connect (1400) to a second Blog Website (1220) which includes a second Blogroll (1225) that lists (1480) a single RSS Feed (1130), that is also listed (1470) by the first Blog's (1210) Blogroll (1215), but the second Blogroll (1225) does not list the other RSS Feeds (1110 and 1120) that are listed by the first Blog's (1210) Blogroll (1215). The single RSS Feed (1130) includes or links to (1460) the other media (1040) item, but not to any of the other items (1010, 1020, and 1030). Current Readers and Web browsers do not recognize the duplication over time of the presentation of the other media (1040) item to the user, which results in inefficiency due to the user dealing with the item several times. A way to avoid such inefficiency is needed.

A benefit deriving from the use of feeds is the aggregation of content items from one or more sources into a single resource that can be easily shared. Users subscribe to feeds by entering the feed's link into a Reader, by clicking or dragging an icon in a browser, or other similar interactions that initiate the subscription process using methods well understood by those having ordinary skill in the art. Readers can check subscribed feeds periodically for new or changed content items, obtain any updates that are found, and provide a user interface to monitor changes to and display the content items provided by the feeds.

Syndication in feeds is a focus of many news aggregators, Reader software vendors, and others because they are able to add value to information content supplied by themselves or others, such as through display, filtering, rating, commenting, collecting, and advertising. However, the Reader software is limited in that they can only deal with the content items presented by one or more feeds. This leaves out much available content that is not syndicated. In addition to this limitation, many feeds (New York Times articles, for example) include summary information rather than complete content items, resulting in a need for users to shift back and forth between their Reader to view the feed-provided summary, and instances of their Web browsers in which they are viewing the Website where the full version of the content item is located. Better integration of feeds and the associated Websites where the content items are provided is needed.

Even when feeds include full content items rather than summaries, users often prefer to read content items in context on the source Website rather than reading the same content items solely within the context of a feed. The original Websites are typically laid out with substantial visual appeal and use various means to supply users with additional features of interest (e.g., Top 10 lists, Recommended Articles, sidebars, or personalized advertisements). Also, Readers typically display information in a sparse and utilitarian manner that users can find unattractive. A more aesthetic presentation of feed-supplied content items is needed to overcome such aversions. Furthermore, a method of automatically organizing and generating feeds such as Top 10 lists, recommended content items, and so on, is needed to ease the workload of the Website maintainer while improving the ability of users to find meaningful content items.

Readers often incorporate the capability to track the content items within feeds that a user has viewed and the items that the user has not viewed, but this is limited to content that the user views using the Reader. There is currently no way for a particular Reader to know when a user has viewed particular content by other means, such as with a Web browser or even a second Reader. This tends to make using Readers an all-or-nothing proposition-they can be very useful if all viewing activity involves them but if the user views content by other means, the read and unread tracking is incomplete and less useful. Some means by which a Reader can be supplied with information about the reading history of the user, whether the prior reading was done using a first Reader, a second Reader, a Web browser, or other means, is needed.

Another limitation of current Readers is that they cannot determine when two items in different feeds refer to content that is similar to, or even exact duplicates of, each other. Most current Readers do not compare items or the content they reference between feeds at all, and therefore do not detect when the same item, a copy of it, or a substantially similar item appears in several feeds. When a first item and one or more second items are identical copies, or even the same content being referenced as part of several feeds, identifying them as duplicates is a simple matter, well understood by those having ordinary skill in the art, and a Reader capable of doing so is needed. When a first item and one or more second items do not reference content items that are identical copies, but nevertheless contain information that is redundant enough that only one of the content items is of interest to the user, current Readers and Web browsers, cannot recognize this and therefore present the user with all items and the same content may be viewed several times. This is a waste of the user's time, and a method for avoiding this is needed to improve efficiency of the system.

Similarity of items can be determined by use of artificial intelligence (AI) techniques, or semantic analysis using ontologies or other well-known methods. Similarity data indicates the degree to which two items are related, whether by topic, length, reading level, publication time/date, author, keywords, tags, and/or other factors. Software capable of such analysis is used by aggregator Websites, such as provided by Epivoz Corporation of Menlo Park, Calif., to group items so that users are presented with several look-alike stories. Alternatively, a static set of metadata related to each item can be created by the item's author, publisher or another service, and associated with the items, such as by including the information in the item description or other feed entry.

Similarity data can indicate the subject the item covers (e.g., the Celtics win the playoff game), the topic area covered (e.g., basketball) or selected keywords (e.g., “playoff”, “Celtics win”, the date and name of the MVP). Topic areas can overlap and be hierarchical (e.g., “basketball” and “sports”, with “basketball” being a sub-type of “sports”), and multi-dimensional (e.g., “basketball”, “sports”, “U.S.”). Whether a first item is identical to a second item is a binary, yes-no relationship, with such items being deemed “Duplicates”. A first item can be a sub-set or a super-set of a second item as well (e.g., one item is a sampling of the initial text of the other, or one item is an abstract of the other), or be different in many respects, while still being “similar”. For example, an item containing details of a first player's performance in the Celtics playoff game is similar to, in some sense, a second item containing details of a second player's performance in the same game. The degree of similarity between two items can be represented by a simple value, such as a percentage, or as a complex multi-dimensional relation representing several factors each by separate values.

Syndicated content sources, such as blogs publish items at varying frequencies. Some sources publish many pieces of content per day, others publish at a lower frequency, such as once a week. Syndicated content sources that syndicate user generated content such as comments can easily produce thousands of different pieces of content in a very short period of time. If users do not visit a frequently changing content source, or view it through a feed, for a few days, a large number of unread items can accumulate. Users often try to catch up by reading the newest items first, but if they do not catch up completely, and read all the un-read items before additional items are added, and this pattern repeats, and results in “islands” of unread material scattered through a chronological listing of both read and unread items. This problem is somewhat ameliorated by using a Reader that tracks read and unread items, but most users do not use such Readers for various reasons, as described above.

The blog format is commonly used by news Websites to publish news content items, and many users subscribe to feeds from such Websites to stay current on topics of interest. Topics of interest are frequently business-related, and users make use of feeds from news Websites to stay current with happenings in their industry. In larger businesses this effort is often duplicated as each interested employee subscribes to similar feeds, reads the same content items and, when one is of particular interest, forwards a link to the article to co-workers to spread the information within the company. Similar patterns occur in social groups, hobby-related groups, or other collections of users sharing a common interest. At present there is no simple and efficient way to coordinate such efforts to reduce the duplication of effort. Sending links in e-mail can be problematic when there is a large volume of mail that the message can be lost in, or when a mail filtering system treats messages containing links as questionable or hazards to security, or when company or individual policies prohibit following links that arrive in e-mail for security reasons. A means of allowing users to form arbitrary groups, coordinate their reading within such groups, and to refer each other to items of interest is needed.

Blog posts typically appear in a blog for a limited period of time, and are then moved to a more permanent location, called an “archive”. This permits past posts to be read at any time, without the actual blog becoming unwieldy and increasingly slow to load into a browser due to ever increasing size of the main pages. To keep track of posts as they move from the blog's main pages to the archive, a URL that remains unchanged indefinitely, called a “permalink”, is used. There is no standard for permalink format that is agreed to by all logging software creators or loggers, and several different formats are in use, such as:
1. Movable Type and TypePad: http://<username>.typepad.com/<username>/<4 digit year>/<2 digit month>/<15 character name>.html
2. Blogspot: http://<username>.blogspot.com/<4 digit year>/<2 digit month>/<article name>.html
3. WordPress: http://<Website-specific prefix>/<4 digit year>/<2 digit month>/<2 digit day>/<article name>/
4. WordPress.com: http://<selectedsubdomainname>.wordpress.com/<4 digit year>/<2 digit month>/<2 digit day>/<article name>/
5. LiveJournal and Bloglines:
http://<username>.livejournal.com/<unique integer identifier>.html
http://users.livejournal.com/<username>/<unique integer identifier>.html (for usernames beginning or ending with an underscore)
vhttp://community.livejournal.com/<community name>/<unique integer identifier>.html (for communities)

Some form of universally applicable identification tagging system for feed items is needed so that a given item can be recognized, regardless of the feed it comes from, or what the URL looks like. These and other needs are addressed by the technology of the exemplary implementation of the current invention, described below.

### SUMMARY OF THE EMBODIMENTS OF THE INVENTION

The foregoing is solved or alleviated by the present invention, embodiments of which include the methods, systems, and software described and illustrated herein.

In a first aspect the present invention provides a method for providing information from one or more data feeds to a user. In some embodiments, the methods provided by the invention include obtaining at least one putative feed; confirming that the putative feed is a feed; extracting at least a portion of content from the feed or data related to the content from the feed; processing the extracted content or the data to produce a synthetic feed; and presenting the synthetic feed to the user. In more specific embodiments, the putative fee is selected from the group consisting of: RSS feeds and Web syndication feeds. In still more specific embodiments, the portion of the content or data related to the content is selected from the group consisting of: blog posts, podcasts, videos, and Web pages.

In yet more specific embodiments, the action of confirming includes determining that the feed is associated with a feed-specific URL. Still more specific include those in which the confirming includes determining that the feed includes at least one tag string, and more specifically scanning the feed for data patterns associated with feeds or applying artificial intelligence to identify the patterns (or both).

In a second aspect, the present invention provides a system for providing information from one or more data feeds to a user. In some embodiments, the systems provided by the invention comprises: a communications process constructed and arranged to obtain at least one putative feed; a confirmation process in electronic communication with the communications process; the confirmation process constructed and arranged to confirm that the putative feed is a feed; an extraction process in electronic communication with the communications process and the confirmation process; the extraction process constructed and arranged to extract at least a portion of content from the feed or data related to the content from the feed; a producing process in electronic communication with the extraction process; the producing process constructed and arranged to process the extracted content or the data to produce a synthetic feed; and a presentation process in electronic communication with the producing process; the presentation process constructed and arranged to present the synthetic feed to the user. In more specific embodiments, the communications process is constructed and arranged to receive at least one putative feed is selected from the group consisting of: RSS feeds and Web syndication feeds. In still more specific embodiments, the portion of the content or data related to the content is selected from the group consisting of: blog posts, podcasts, videos, and Web pages. In other embodiments, the confirmation process is constructed and arranged to scan the putative feed for data patterns associated with feeds. Other embodiments further include a compiling and storing process constructed and arranged to compile and store Reading History Data and Reader Interest Data. In some embodiments, the producing process is constructed and arranged to use at least one of the Reading History Data and the Reader Interest Data to compile the synthetic feed.

A computer readable medium containing computer readable program control devices thereon, the computer readable program control devices being constructed and arranged to enable a computer to provide information from one or more data feeds to a user, comprising: instructions constructed and arranged to enable the computer to obtain at least one putative feed; instructions constructed and arranged to enable the computer to obtain confirm that the putative feed is a feed; instructions constructed and arranged to enable the computer to extract at least a portion of content from the feed or data related to the content from the feed; instructions constructed and arranged to enable the computer to process the extracted content or the data to produce a synthetic feed; and

These and other aspects and advantages will become apparent when the Description below is read in conjunction with the accompanying Drawings.

### BRIEF DESCRIPTION OF THE DRAWINGS

FIG. 1 is a schematic diagram of the relationships between content items, RSS feeds, blogs, blogrolls, and Web browsers or Readers according to the prior art.

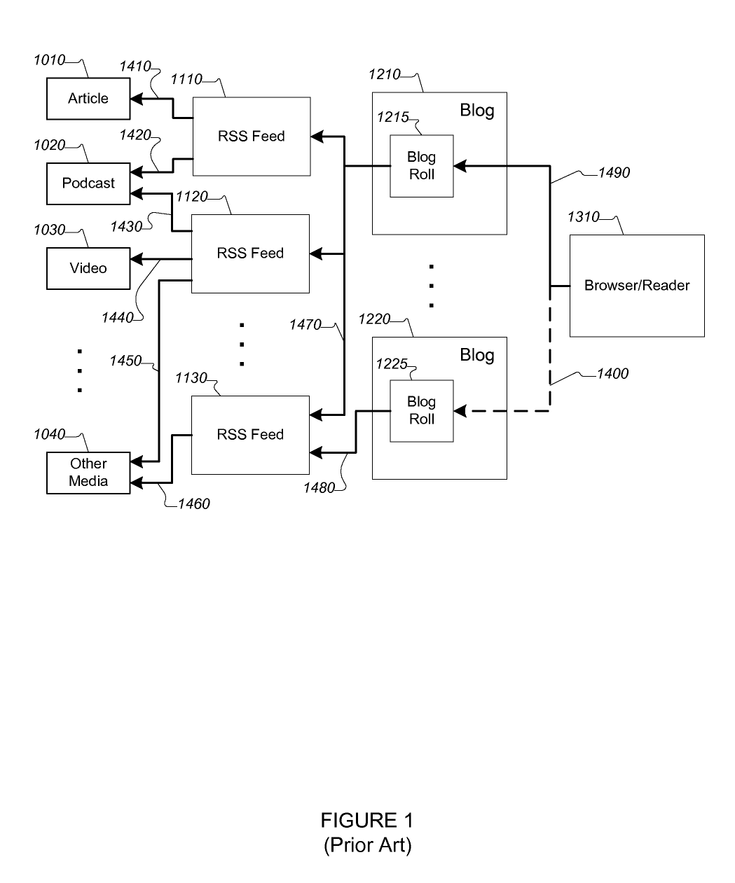

FIG. 2 is a schematic diagram of the relationships between the MBR Website and the User Data it includes, a Web browser with an MBR widget making use of the MBR Website User Data, and a pair of Websites supplying MBR widgets and feed data, in accordance with one embodiment of the invention.

FIG. 3 depicts a blogmap, showing the types and strengths of the relationships between several blogs that share a blogspace, in accordance with one embodiment of the invention.

FIG. 4 is a flowchart that describes an exemplary process for updating a Most Popular List, in accordance with one embodiment of the invention.

### DESCRIPTION OF SOME EMBODIMENTS OF THE INVENTION

### Overview

The present invention provides software, systems, apparatus, and methods for collecting, processing, and presenting RSS Feeds and other content provided using Web syndication feeds (referred to herein generally as “feeds”) to a user. More particularly, the software, systems, apparatus and methods provided by the present invention include obtaining, assembling and republishing, displaying, tracking the contents of, and customizing lists of, feeds and the referenced and included content of those feeds. In addition, the software, systems, and associated methods provided by the invention further enable tracking content both read and not read on a user-by-user basis (referred to hereinbelow as “Reading History Data”, “RHD”), collecting and using data about the content items read using other software or devices, determining the level of reader interest in the content items viewed (referred to hereinbelow as “Reader Interest”, “RI”) and saving the associated usage and reader interest data for later use, and determining the degree of similarity between content items. Furthermore, the present invention provides for suppressing or marking display of previously viewed or redundant items (or both) to improve user efficiency. In addition, the present invention provides for controlled sharing and use of collected RHD as well as feed or other data between associated users. An exemplary embodiment of the invention further provides synthesized feeds derived from one or more feeds according to user-defined parameters, e.g., according to lists of recommended content items, according to collections of items having similar topics, according to lists of content items that should be read with a particular priority (individually or in some combination thereof). In some embodiments, the synthesized feed provides one or more depictions of a given Website in relation to other Websites to which the first Website has links, or which Website is linked by other Websites, or tracks content item popularity based upon content item views, reader interest, references (links to a content item) on other Websites.

In some exemplary embodiments, the invention is implemented using a software device that comprises a “widget” or “applet” associated with a Web page and intended for download and use within Web pages as presented by commonly available Web browsers. In other exemplary embodiments, the invention is implemented using a browser feature built into a browser, a browser plug-in that is installed by a user, a stand-alone application program invoked by a browser or other display application, an interactive Website (such as developed, e.g., using FLASH software (Adobe Systems, San Jose Calif.), or other equivalently capable implementation. The provision of such implementations will be understood to those having ordinary skill in the art.

In a first aspect, the present invention provides methods for providing information from one or more data feeds to a user. In some embodiments, the method of the invention includes: obtaining at least one putative feed; confirming that the putative feed is a feed; extracting at least a portion of content from the feed or data related to the content from the feed; processing the extracted content or the data to produce a synthetic feed; and presenting the synthetic feed to the user. In some more specific examples of this embodiment, the putative feed is an RSS feed or a Web syndication feed. In still more specific examples of this embodiment, the portion of the content or data related to the content is selected from the group consisting of: blog posts, podcasts, videos, and Web pages.

In other more specific examples of the above-described embodiments, the operation of confirming includes determining that the feed is associated with a feed-specific URL, and, more specifically, further determining that the feed includes at least one tag string. In other embodiments, the operation of confirming includes scanning the feed for data patterns associated with feeds, and, more specifically, applying artificial intelligence to identify such patterns.

Still other embodiments include those in which the operation of processing includes identifying putative duplicate feeds, which may further include identifying putative similar feeds, or alternatively include identifying putative similar feeds. In yet other embodiments, the processing operation includes identifying putative equivalent content.

In still other embodiments, the above-described processing includes compiling and storing Reading History Data and Reader Interest Data, both of which are described below. Other embodiments include those in which the processing includes using at least one of the Reading History Data and the Reader Interest Data to compile a synthetic feed as described below.

In a second aspect, the present invention provides apparatus and systems for providing information from one or more data feeds to a user that comprise process constructed and arranged to perform the above-described operations. Such systems and apparatus typically are programmable electronic communications devices as will be understood by those having ordinary skill in the art. The devices may be provided singly, in which all or substantially all functions necessary to implement the present invention are provided on a single device, or several device in appropriate communication can be used. The provision of such suitably constructed and arranged apparatus and devices will also be familiar to those having ordinary skill in the art.

In a third aspect, the invention provides a computer readable medium containing computer readable program control devices thereon, the computer readable program control devices being constructed and arranged to enable a computer to provide information from one or more data feeds to a user, comprising instructions constructed and arranged to cause a computer to implement the various operations described above. The provision of such devices will be familiar to those having ordinary skill in the art.

### Exemplary System Components and Architecture

### Widget-Type Implementations (the “MBRW”)

Given the wide variety of techniques and designs in which the present invention can be implemented, for purposes solely of description and not limitation, the methods, systems, apparatus, and software provided by the invention will be described herein with reference to the “MyBlogRoll Widget” (“MBRW”). Those having ordinary skill in the art will understand the reference to the MBRW does not in any way preclude or limit the various alternate embodiments of the invention or the scope of the invention.

In one embodiment, the MyBlogRoll Widget (MBRW) includes a component that is useful for interfacing between the system of various embodiments of the invention and a Web browser, and between the system in various embodiments of the invention and a user, for purposes of carrying out the functionality of various embodiments of the invention, such as collection of Reading History Data (“RHD”) and Reader Interest (“RI”) data, manipulation and access to Document Object Model (“DOM”) data in Web browsers, input of user commands, display of information to a user, and other functions as described herein.

For purposes of this description it will be assumed that the exemplary MyBlogRoll Widget (MBRW) is embodied in a “Web widget”. As will be apparent to those of ordinary skill in the art, the exemplary MBRW can be embodied by other methods, such as a standalone application, a browser plug-in module, a browser native capability, or as a Web-based service. A combination of these methods also can be used, and some aspects of the exemplary implementation described herein will include both Web widget and Web-based service techniques to demonstrate this clearly.

A Website owner that chooses to support use of the MBRW on their Website can customize the MBRW in various ways as described herein. For example, they have the capability to alter the color scheme, widget size, and text font used as well as various aspects of MBRW behavior, such as the number of items in the Most Popular List and how such items are selected, which users, systems or applications have access to collected RHD, and so on. Default configuration settings are used for those settings that users and Website owners have not explicitly altered to their own preferences.

### Exemplary Architecture for Widget Implementation

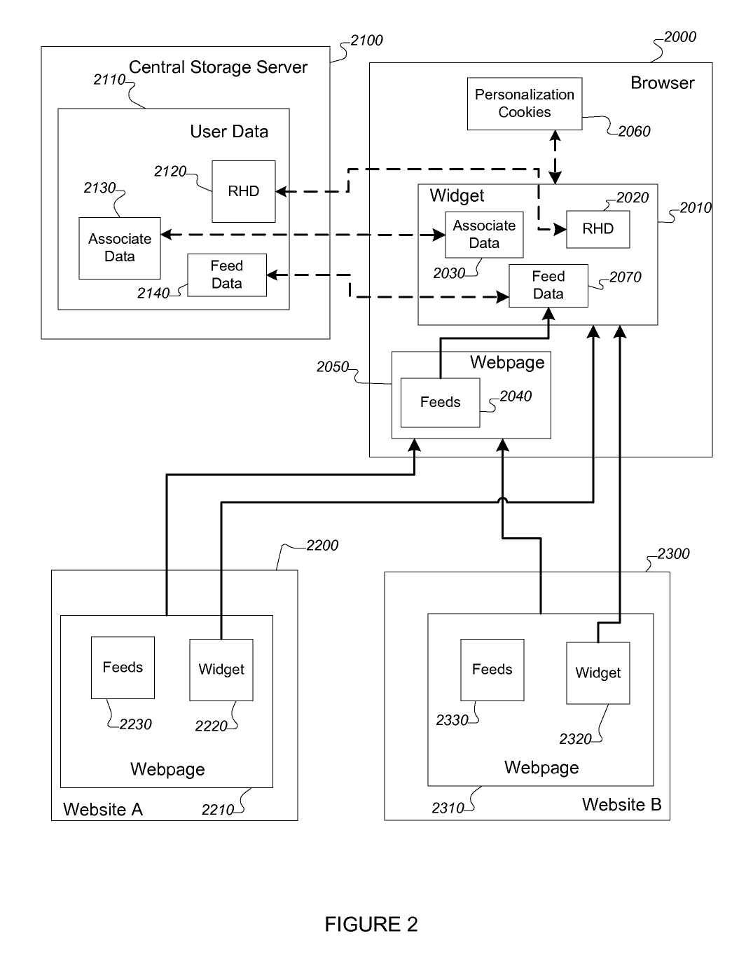

FIG. 2 depicts an exemplary embodiment of the above-described widget-type implementation of the current invention, i.e., using the MBRW, (2010) instantiated inside of a Web browser (2000). Browser 2000 and MBRW 2010 are processes running on an electronic computing device (not shown) familiar to those having ordinary skill in the art, and in electronic communication with first and second Websites (2200 and 2300) as well as a central storage server (CSS, 2100) that stores and supplies user data (2110) including RHD (2120), user association data (2130), and feed data (2140) the details of which are provided hereinbelow. Websites 2200 and 2300, and CSS 2100, are provided using electronic computing and storage devices (not shown) that are familiar to those having ordinary skill in the art. Initially, in one embodiment, the user's browser (2000) obtains the MBRW (2010), in this example, from one or both Websites to which the browser (2000) has connected. For example, when the browser is directed to connect to a Website that supports the MBRW, such as first Website (2200), the first Web server downloads (dashed lines) the MBRW (2220) along with the Web page data (221 0). The Web page can also include a blogroll or other feed (2230) or links thereto. The user's browser (2000) instantiates the downloaded MBRW (2010), which connects to the CSS (2100) to acquire the user's RHD (2120), association data (2130) and feed data (2140), and downloads the data into the MBRW (2020, 2030 and 2070). The MBRW also acquires user-specific Personalization Data (2060), which can be stored, e.g., in cookies, in the user's browser. Alternatively, the personalization data could be stored on the CSS (2100) as user data (2110), or be obtained by other methods as determined to be proper by those having ordinary skill in the art. As with the first Website (2200), downloading the second Website's (2300) webpage data (2310) also downloads a new instance of the MBRW (2320) and any feed or link data (2330) on the second webpage (2310). The MBRW (2320) is instantiated (2010) by the user's Web browser (2000), connects to the CSS (2100) and obtains the user data (2110), which includes the RHD (2120) and association data (2130) for the user. The user data (2110) includes any RHD updates made by the previously used instances of the MBRW, which enables the MBRW instance (2010) to suppress or tag any items on the second Web page (2310) that the user has already viewed from the first Web page (2210), or other Web pages (not shown) previously. The details of these actions and elements are described below. Providing the various hardware, software, and communications links just described will be apparent to those having ordinary skill in the art.

### Feed Data

In one embodiment, during operation the MBRW (2010) scans a loaded Web page (e.g., Web page 2050) to locate any feed data (e.g., feed data 2040). In more particular embodiments, suitable feed data on Web pages is identified from RSS headers, URIs, and Web page text that compose the feed. Additional methods of identifying feed data are described below. In more particular embodiments, as the user reads the Web page (2050) and the associated feeds (2040), the RHD is updated (2020) both within the MBRW (2010) and on the CSS (2120). If the user moves on to a second Web page (2310) on the second Website (2300), the Web browser (2000) terminates the MBRW instance (2010) and clears the current Web page data (2050), including any embedded feed data (2040), before loading the new Web page data (2310) from the second Website (2300).

### Identification of Feeds

For feed data to be useful, the putative feed data must be recognized or confirmed as a feed or a link to a feed. There are a number of possible methods for meeting this requirement.

A first method for identifying a feed reference is the use of a feed-specific Universal Resource Locator (URL) scheme, as described above. Implementation of this method will be familiar to those having ordinary skill in the art.

A second method includes the use of identifying standardized “tag” strings in known locations in the feed link URL, such as in particular parameters or file names, or in the feed or feed items, as is done with some graphical file formats. Implementation of this method will be familiar to those having ordinary skill in the art.

If a feed cannot be identified by URL format, other methods can be used, such as Artificial Intelligence (AI) pattern matching techniques. Such techniques are useful when examining links to other Websites that can contain feed links or feeds. Examination of data streams or other objects for feed links or feeds can be done by the MBRW, or by another system in support of the MBRW, as determined to be proper by those having ordinary skill in the art. Implementation of this method will be familiar to those having ordinary skill in the art.

When a Web page supports the MBRW, the Web page can specify the Website's own feed information, or links to the feed information, as part of the configuration of the MBRW, whether provided in the Web page object that specifies the MBRW, in a Website file accessed from the MBRW, in (X)HTML header <meta> tags in the Web page data, on a central shared MBRW server system, in cookies set in the user's Web browser, or elsewhere known to the MBRW as implemented in a particular exemplary embodiment. Implementation of this method will be familiar to those having ordinary skill in the art.

### Duplicate Item Recognition

In some embodiments of the invention duplicate feeds are identified and processed as described below. Because feeds commonly include references to items that are generally visible to the entire Web, such as news stories on news Websites, essays on blog Websites, images on image Websites, and so on, it is common for several feeds to contain items that refer to the same posting, article, blog entry, image, podcast, or other media. Such duplication can result in inefficient viewing for a user, as the duplicated items occupy space in the item list(s), require user attention to recognize as duplicates, and often result in unproductive full-item retrieval and viewing. The duplicate items appear to be separate items, but are actually just several references to the same item, or copies of the same item. Implementation of this method will be familiar to those having ordinary skill in the art.

In those embodiments of the invention in which duplicate feeds are identified, the MBRW recognizes duplicate feeds or content, whether on one feed or between several feeds, and modifies or suppresses such duplication before presenting the feed to the user. In other exemplary implementations, the user is provided with an option to view duplicate items. A first example of duplicate item suppression involves a first feed, viewed on Monday, which contains an item referencing a Web page describing a new windmill design. The user views the Web page on Monday, and the item is marked as “read” in the RHD for the user, and no longer appears in the user's list of items to be viewed. The item is removed from that feed on Wednesday, but the “read” information is retained in the RHD. Current Readers only maintain “read” information on items currently in feeds, so when the item is removed from the feed, current Readers delete their “read” information. On Friday, the feed again contains an item referencing the windmill's Web page. Current Readers, which do not retain information about the viewed/not viewed state of items that are not currently in a subscribed feed, do not recognize that the item has already been read, and again put it on the “to be read” list. The user spends time retrieving the Web page, only to find that there is nothing new to view there. The MBRW, using the more persistent RHD, recognizes that the item has already been viewed, and does not add it to the user's list of items to be viewed. Implementation of this method will be familiar to those having ordinary skill in the art.

In a second exemplary illustration, the user subscribes to two feeds that carry content related to technological topics. When a new smart phone is released, two different bloggers write posts about the device, one pro, one con, and both include links to the phone manufacturer's Website page about the new phone in their “Recommended Sites” feeds. Current Readers, which do not cross-check items in different feeds, will list both items, one from each feed, even though the two items are links to the same Website. The user may or may not recognize the items as identical in this scenario, but the additional item will still occupy space in the lists of items to be viewed. The MBRW, using RHD that records items viewed from all of a user's feeds, recognizes that the user has already viewed the phone manufacturer's Website page about the new phone while viewing the first feed items, and does not include the Website in the list of items to be viewed for the second feed. This reduces the size of the to-be-viewed list and makes more efficient use of the user's time. Implementation of this method will be familiar to those having ordinary skill in the art.

One method for determining whether a feed item is a duplicate of another is to compare the feeds or relevant feed content directly. While this method works in some cases, it is not reliable in all scenarios. For example, if two items include URL links to the full content of an item, they can be identical, but if they are separated in time, and the content has been altered between the creation of the first item and the creation of the second item, the two items should not be considered duplicates. The changes in content may well be of interest to the user, and suppression of the updated content due to the updated content having the same URL as the prior content would be incorrect. In another example a Web page is copied from a first Website to a second Website, and each is included in a feed subscribed to by the user. The content in this scenario is identical, but the URL addresses are different, thus making the items in the feeds different, but still identical from the user's perspective. Simply comparing the feed items is insufficient to determine whether the content represented by the items is duplicated. Despite this, a simple comparison of the items can be a useful first test in most cases, and can be definitive when the feed items include the full content of the item, rather than just a summary or fragment of the content with a link to the remainder of the content. Implementation of this method will be familiar to those having ordinary skill in the art.

Another method for comparing feeds and their content can be accomplished by methods that are well understood by those of ordinary skill in the art, such as a byte-by-byte comparison, statistical sampling of fragments of content, comparison of computed checksums of the content or by combinations of these or other methods, such as comparison of computed checksums of statistically chosen fragments of content. Methods which reduce the content to a relatively small but still representative piece of information, such as the checksum method, are particularly useful, since they result in easily stored, transmitted and efficiently handled data that can be stored with the user's RHD for future reference. Implementation of this method will be familiar to those having ordinary skill in the art.

The MBRW's ability to compare items, even when the items appear in different feeds, and to suppress display of duplicate items in “to be read” lists, eliminates the problems of the current systems. The MBRW's ability to make use of RHD to identify items previously viewed by the user, regardless of the feed in which the items appear, and regardless of when this occurred, further eliminates other problems of current systems.

### Duplicate and Similar Feeds and Content

Duplicate fees or feed content, whether in one feed, several feeds, or over a span of time, are relatively easy to detect using methods well known among those of ordinary skill in the art. A more difficult problem involves the detection of similar, but not identical, items. For example, it is not uncommon for content to be copied from one Website, and placed on another Website, with modifications that do not change the substance of the item, but do change the appearance or content of the item enough that the two are not duplicates of each other in the sense used above, but which can be considered to be the same by a user. For example, if a news story about airline flight safety is copied from a newspaper's Website, where the news story appears in the newspaper's Website's feed, and placed on an airline employee union's Website, where the news story appears in the airline employee union's Website's feed, a subscriber to both feeds would receive two items, each comprising the same news story, but with enough differences, such as the union Website's version including text noting that the article is used with permission along with the name and URL of the news organization that created the article, that a simple comparison of the item or the content would not detect the similarity. The two items are not identical, but they are similar enough that the user is unlikely to be interested in reading both of them, and would prefer that one or the other be suppressed.

There are other scenarios where similarity of items is of interest. For example, when a user is interested in reading as many content items with similar content as possible, such as, when wanting to read as much as possible about an upcoming Super Bowl, or when researching alternative energy sources. In both scenarios a means of recognizing that two items, while not identical, share enough similarities to be classified as “similar” is needed so that both can be shown to the user.

Thus the present invention provides, in some embodiments, the analysis of feeds and content using methods as described above to determine the level of similarity between two or more feeds or feed content. In some embodiments, the content analysis is done by software on the user's system, and in other embodiments on a server. For example, such server-based analysis software can be located on the server of the Website hosting the content, or on a centralized server which can service multiple clients by analyzing content items sent to the centralized server. Implementation of this method will be familiar to those having ordinary skill in the art. For example, suitable technologies include those employed commonly with “spyware” programs to track what has been read across multiple Websites. Implementation of this method will be familiar to those having ordinary skill in the art.

In one embodiment, users, loggers, Website owners, or the MBRW can set the level of similarity required between two items that will result in elimination, tagging, counting or otherwise acting on several items as being similar. Implementation of this method will be familiar to those having ordinary skill in the art.

Current Readers do not support automatic recognition of similar, but not identical, items, particularly not between different feeds. At best they rely on “tags” provided by content creators or added by users through “public bookmark” Websites, such as http://del.icio.us by Yahoo! Inc. of Sunnyvale, Calif. The ability of the MBRW to automatically recognize the similarity of diverse items provides a great improvement to users' ability to find, or avoid, similar content in feeds or on Websites.

### Denoting of “Equivalently-Read” Stories

In some embodiments, after the MBRW determines that two or more items are identical or similar, the MBRW suppresses or modifies the display of the duplicate or similar items. In another embodiment, the MBRW displays the items, but in a manner that makes it clear to the user that the items are duplicates of, or similar to, other items. In a more specific embodiment, when the RHD shows that an item in a feed is identical to one that's already been read, the MBRW marks the item as “read”, or, alternatively, “duplicate”. in another specific embodiment, when it is advantageous to track how many times an item has been read, the MBRW increments a counter and indicates the count in association with one or more examples of the duplicate item. In still another embodiment, redundantly read items are displayed in a more analog manner, such as with shading or color, type size, or a gauge (e.g., an expanding “progress” bar, a “speedometer”, and so on), or varying degrees of title truncation to show the number of times that an item has been read in one Feed or another. Yet another embodiment includes a command or other process, e.g., a menu selection, for the user to obtain a list of redundant items from the feeds subscribed to. Implementation of this method will be familiar to those having ordinary skill in the art.

In still other embodiments unread duplicate or similar items are deleted from lists of items and ignored. Implementation of this method will be familiar to those having ordinary skill in the art.

### Synthetic Items and Feeds

In addition to collecting and processing feeds from the user's subscription list, and from those feeds that appear in the feeds from the user's subscription list, in some embodiments, the MBRW generates items and feeds from existing items and feeds, from metadata concerning existing items and feeds, or from its own processing. In some embodiments, this is done internally to the MBRW for the use of the user, optionally inclusive of data obtained from other sources, such as the central storage server (CSS), or by the CSS using stored RHD, Reader Interest (RI), feed, or other data. In more specific embodiments, the resulting items or feeds are sent to MBRWs, or stored in the CSS or on other common systems, and shared between the user's associates. Implementation of this method will be familiar to those having ordinary skill in the art.

In some embodiments, the items are synthesized from metadata such as a list of feeds a user or group of associates is currently subscribed to, such a list being sorted by items in a given period of time, sorted by the number of associates subscribed, the number of duplicate items between feeds, and so on. In other embodiments, feeds are synthesized from the set of feeds a user or a group of are subscribe to, from the bookmarks in a user's browser, or from the links found on the Web pages visited by a user in a given period of time. In more specific embodiments, any data available to, or calculable from data available to, the MBRW or the CSS is synthesized into an item or feed, or both. In still other embodiments, the Website the MBRW is obtained from supplies additional input for, or controls the generation of, synthesized items and feeds by the MBRW while it is interacting with that Website. In other embodiments, when the user moves to a second Website, and a second instance of the MBRW is instantiated, a different set of inputs and controls can result in the generation of different synthesized items or feeds. In still other embodiments, the MBRW exports synthesized items, feeds or information related to these, such as by use of HTML “POST” requests to Web servers constructed and arranged to accept them, or by storing them on the CSS or the user's system (e.g., in disk files where that is permitted, or in the form of browser cookies). Implementation of this method will be familiar to those having ordinary skill in the art.

An example of a synthesized item created under control of the Website hosting the MBRW is a “Community Top 10” table and associated feed, synthesized by the Website using RHD from the CSS to determine the Websites most frequently visited by those users who also visit the Website. The Website uses extracted, and possibly summarized by the CSS to eliminate personally identifying information, RHD to determine the top 10 Websites, and visits each one to collect their feeds to form a synthesized blogroll feed and an auto-generated HTML table that includes the names of the feeds in the “Community Top 10” table, each item in each feed, and the first paragraph of each item's associated content. The HTML table appears on the Website, along with an icon that permits the associated feed to be used by visitors to the Website. Such an automatically generated item can serve to keep a Website active and to keep the author in touch with the users even if the Website maintainer does not have time or interest in producing a fresh item at a given time.

Alternatively, users can benefit directly from auto-generated items. In some embodiments, a user instructs the MBRW to construct a synthetic feed of the Top 10 feeds in the user's list of feeds, or from a subset of these (that is, a personalized blogroll). Such synthetic feeds can be exported and viewed via a separate Reader or by the MBRW. The user controls the frequency and composition of such a feed, including whether descriptions, author names, dates, full content or summaries, and so on are included, as well as viewing metadata resulting from the calculations that determine the items from which the synthetic feed is made. Implementation of this method will be familiar to those having ordinary skill in the art.

Many Websites and blogs offer an option to users to have periodic (that is, daily, weekly, and so on) contact sent that contains a summary of some or all of the Website's content. In many cases, this contact is provided in the form of email, although other means of contact are well known to those of ordinary skill in the art. Some of these means include Short Message Service (SMS), Instant Messaging (IM), voice mail, e-mail, and RSS feeds. Some users hesitate to request such contacts due to fears that they will be deluged with contacts (at least one from each Website they subscribe to in this way). Many Websites do not offer such a contact feature, which prevents users from a consistent pattern of Website use even if they are willing to sign up for such a contact system. In some embodiments, the MBRW system generates synthetic lists of content items created based on various criteria, and, in more specific embodiments, sends the lists to users, potentially reducing to one the number of contacts in the form required to obtain information about all of the feeds they subscribe to, and obtaining the information in this way whether the Websites in question support notifications (contacts) of Website changes or not. From the Website maintainer's perspective, such an contact helps to generate Website traffic (as users follow the links in the contact to the Website, or forward the contact materials to associates and the associates follow the links and perhaps decide to add the Website to their own feed lists). For users, the notification contact materials are a direct route to get to their favorite Website's new content items, content items that are currently getting the most attention from others, or content items selected by other criteria. Implementation of this method will be familiar to those having ordinary skill in the art.

In addition to, or instead of, the listed contact methods, in some embodiments the MBRW transmits the contact materials as synthesized feeds or send the contact items using other means, such as IM, SMS text messages, posts to Usenet News (a distributed message sharing system), posting to the user's Facebook (a social networking Website operated by Facebook, Inc of Cambridge, Mass.) wall (a space on a user's Facebook profile page that allows posting of messages), or as a separate feed in the user's feed list. Implementation of this method will be familiar to those having ordinary skill in the art.

In another embodiment, the above-described synthetic items are based at least in part on content stored in the RHD.

### Feed Sharing

In certain embodiments, users permit their feed subscription data to be shared with associates. This can be at the level of subscriptions (that is, the data describing a feed, such as the feed's URL), which permits the associates to subscribe easily to the feed, or at the level of the feed items, where the item data obtained from the subscribed feed is shared with associates, precluding a need for the associates to obtain their own subscription. When feed item data is shared, the source of the feed gains viewership without increased bandwidth, but loses some ability to track viewer count. In some embodiments, feed data is cached locally to the user and the user's associates, which can improve apparent speed if the group has a slow link to the net but a fast local network (LAN), but can also result in the data being out of date if the feed is to a source that changes frequently. Appropriate setting of cache retention times can reduce this problem. Implementation of this method will be familiar to those having ordinary skill in the art.

### Item Identification

Items are located by way of URLs, and a URL is a unique way to locate a given item at any particular time, but different content can appear at any URL over time, and the same content can appear at more than one URL. For example, a URL that indicates a Website's main page will locate diverse content over time as the Website maintainer adds, edits, deletes, and archives items. To keep track of RHD over time and across several feeds, over time, a more universal and unique method of identifying particular content items is required. In general for blogs, a permalink serves as the “universal ID” for a feed item, but even with blogs there is no standardization of permalink formats, making it awkward to determine whether two feed items are referring to the same content. In some cases, permalinks for items can be difficult to obtain. For example, while all articles on the New York Times Website are part of one feed or another, and each possesses a permalink, when these articles are viewed on a composite page comprising multiple stories (e.g., the front page of the Sports section) the permalink for a specific story may not be available.

In some embodiments, the MBRW scans the Website, and any feeds the Website includes, to locate and correlate permalinks to the items on the Website. Using text-matching methods, the system compares portions of the Website (such as blog posts) with the items contained in, or linked from, the associated feeds to determine the Website's permalink for each part of the Website. Such an ability to determine permalinks is used in some embodiments to relate collected RHD to the content that was read, in a manner that will remain valid over useful periods of time. This capability is useful for implementation of the concepts described herein, such as supplying MBRW and Readers with read/not read information for items viewed by methods separate from the MBRW. Implementation of this method will be familiar to those having ordinary skill in the art.

Readers that Take Users to Pages of Origin

Some users prefer to view items on the Web page where they originate, rather then from a permalink page featuring just one item, just as some users prefer to view on an original Website rather than via a feed Reader. In some embodiments, the MBRW system, using the Item ID method described above, offers users the option of navigating to the original Web page of an item rather than to a permalink page, since the MBRW system has both the original URL of the item and the permalink in its storage. In more specific embodiments, the user navigates by use of feed items, but is presented with views of the items in their original context, rather than a typical Reader format, when the original context is still available, and in a permalink format when the original context is no longer available. Scenarios where the original context is no longer available can be minimized by use of internet archive Websites, such as hosted by Internet Archive of San Francisco, that periodically take “snapshots” of the Web and make the snapshots available at future times. In still other embodiments, if the original Website of an item has changed, such that the original context of an item no longer exists on the Website, an archive Website that may still be able to provide the original context to the MBRW system (and therefore to the user) is sought and accessed if available. Archive Websites typically use original URLs to access content, and the RHD contains such information for each feed item, along with correlations between the permalink and original URL data. Implementation of this method will be familiar to those having ordinary skill in the art.

Websites can assist the viewing of specific items in context by providing means, such as URL attributes, for a Reader to identify the item of interest when accessing a Web page, and then display the Web page with the specified item highlighted in some manner. For example, the Web page can be modified to make the item larger, promote the item to the top of the page, present the item in larger type, put a box around the item, attach an icon to the item, or somehow visually highlight or annotate the item in order to attract the attention of the user more quickly. In some embodiments, on Websites that support the MBRW as a widget, browser plug-in, or other implementation where the MBRW has access to the Document Object Model (DOM) that describes the Web page internally to the browser, the MBRW can alter the DOM so as to accomplish such item of interest enhancements, without the Website having to provide any special facility. Such an MBRW capability can be used for other purposes as well, such as compensating for user disabilities by adjusting color contrasts, text sizes, or suppressing flashing items, based on configuration settings provided by the user in ways described herein. Implementation of this method will be familiar to those having ordinary skill in the art.

### Central Storage System (CSS)

In some exemplary embodiments, MBRW system includes a central data storage server, which, in more specific embodiments, incorporates a Web-based user interface for user access to the user's stored data and for other purposes such as adjusting configuration settings. This central data server is referred to herein as the Central Storage Server (CSS). In some exemplary embodiments, the CSS can take on the functionality of a full-function Reader, as well as permitting users to add, remove, view or otherwise work with their stored data, such as MBRW configuration settings, feeds, associations with other users, and RHD. Implementation of this method will be familiar to those having ordinary skill in the art.

In some embodiments, the CSS includes a single system, in other embodiments, the CSS comprises a collection of cooperating systems, and in still other embodiments, the CSS comprises a set of redundant systems that duplicate the functions of each for redundant stand-by backup purposes. The systems that compose a CSS can be of one or several designs and each can perform similar functions, or the overall functionality of the CSS can be divided between several general purpose and/or specialized systems, as will be apparent to those of ordinary skill in the art. For example, there can be systems dedicated to running Web servers for interfacing with MBRW clients on user systems and for user interaction with the MBRW system, specialized database server systems dedicated to safe, efficient and reliable storage of RHD and other data, authentication servers used to authorize or deny access to the CSS or any part thereof, or other systems, as required. Implementation of this method will be familiar to those having ordinary skill in the art.

### Reading History Data (RHD)

In some embodiments, the invention provides for the creation and management of “Reading History Data” (“RHD”). RHD includes data that describes each feed's content items, such as blog posts, parts of Web pages, podcasts, videos, or other content items that a user has viewed. RHD can optionally include data about one or more feed's content items, such as blog posts, parts of Web pages, podcasts, videos, or other content that a user has not yet viewed but which are contained in feeds that the user is subscribed to, has downloaded, or otherwise expressed an interest in. In some exemplary implementations, RHD includes data about one or more Web pages, parts of Web pages, blog posts, or other content that a user has viewed, or has not viewed, directly on one or more Websites rather than by way of feeds. In some embodiments, such data is complied regardless of the method of access to the RHD storage system (e.g., through a method such as an API, supported network protocol, or other means). Implementation of this method will be familiar to those having ordinary skill in the art.

In some embodiments, RHD is stored in a convenient location, such as on a shared server system, on a private server system, in portable media (e.g., a memory stick, or Universal Serial Bus (USB) “thumb” drive) possessed by the user, or in a user's own browser/reader in the form of cookies or by other methods. Significant benefits are derived by storing RHD in a location that is accessible to the user, the user's associates, and to blogs or other Websites that the user interacts with. In some embodiments, RHD is made accessible to, updated by, and used by instances of the MBRW regardless of the specific storage process or location used. In some embodiments, the RHD is maintained independently of the particular Websites visited by a user, and disparate instances of the MBRW are used to compare a user's reading history across several feeds, Websites, or both, and such RHD information is used to make determinations about which content items should be displayed, how these content items should be ordered in accordance with a priority calculating algorithm, or suppressed (perhaps because they included redundant information). This is advantageous because it makes more effective use of the user's time spent reading content items across Websites. Implementation of this method will be familiar to those having ordinary skill in the art.

RHD has other uses beneficial to the user and the Websites the user visits as well. Such benefits include the ability of the MBRW to identify topics of interest to a particular user, share required reading duties across several users who are simultaneously independently using the MRBW, identify popular content items, and to assist in the creation of dynamic Website content, such as being used to assemble lists of popular content items for further display by other instances of MBRWs. Details of the generation and use of RHD are included below. Implementation of this method will be familiar to those having ordinary skill in the art.

Other embodiments of the invention include friend or group (association) data. In one embodiment, each user is associated with zero or more other users such that the RHD of each user is accessible to each user in the association. In more particular examples of such embodiments, users within the association can view the RHD of other associated users and thereby coordinate their collective reading patterns so as to ensure that all are reading required items, determine which members of the association have read or not read a given item, recommend items to each other, ensure that at least one member of the association has read a given item, or for other purposes. Such capabilities help identify items of interest for users, avoid duplicated viewing of uninteresting items, ensure that items of interest are not ignored by all members of a group, and promote exchange of item links between users. Each of these capabilities improves the utility and efficiency of the system when groups of users share interests or duties in dealing with particular items or topic areas. Implementation of this method will be familiar to those having ordinary skill in the art.

Reading History Data (RHD) includes sufficient information about items read by users to identify and locate those items whether by original location, permalink or both, to recognize duplicates of those items, and recognize items that are similar to those items. RHD can optionally include items which have been included in feeds that the user has received, but that have not yet been read. The exemplary embodiment records the ID of the user the RHD is related to, the URL of each item's original location, the item's permalink, any checksum(s), content fragment(s) or other data used to identify duplicate or similar items, the read/not read state of the item, any priority or “read later” information that a user has associated with the item, an ID of the feed the item was contained in, a timestamp indicating when the item was added to RHD storage, a timestamp indicating when the user originally read the item, a timestamp indicating when the user last read the item, account of the number of times the user has read the item, and any tags the user has associated with the item. Implementation of this method will be familiar to those having ordinary skill in the art.

To determine when an item has been “read”, the MBRW monitors which items have been displayed to the user. This includes those items that have actually appeared on the display device, not merely those that have appeared on a Web page that was browsed. In some cases an entire Web page will not fit in the available display area of the browser and the page is scrolled for viewing. Items which are part of a viewed page, but which did not scroll onto the visible display are not considered to have been viewed. Additionally, the MBRW tracks the amount of time the items were displayed for. If the user scrolls past an item rapidly, the item is not considered to have been viewed. The item must be displayed long enough to have been read to count as “read” by the MBRW. The specific period of time required can be constructed and arranged by or for each user. The actual time required will depend on the constructed and arranged setting as well as the size of the item (e.g., word count), with larger or more complex items requiring more time to count as “read”. In some exemplary implementations, the MBRW supplies a control, such as a button, that permits a user to mark an item as “read” manually. Implementation of this method will be familiar to those having ordinary skill in the art.

The exemplary embodiment of the current invention stores RHD on a CSS, but can maintain RHD temporarily in the MBRW until it can be sent to the CSS, or for use by the MBRW in carrying out its functions. Implementation of this method will be familiar to those having ordinary skill in the art.

In some embodiments, RHD is used by the MBRW for purposes of displaying lists of, or content of, unread items, read items, items by the feed they arrived in, items by time of arrival, items by time of first viewing, items by time of most recent viewing, items by priority, items marked to be “read later”, item view counts, statistical data, such as items arriving or viewed per hour, day, week, and so on, average items arriving or viewed per hour, day, week, and so on, and for use in suppressing or appropriately indicating duplicate or similar items. Implementation of this method will be familiar to those having ordinary skill in the art.

In some embodiments, a user's RHD can be used by MBRW instances used by associates of the user for purposes of displaying lists of, or content of, items the user has viewed, when the user viewed them, lists of, or content of, items the user has not viewed, and any tags the user has associated with the items. Implementation of this method will be familiar to those having ordinary skill in the art.

In some embodiments, with user permission, non-MBRW systems, such as Web servers, can make use of RHD data for various purposes, such as identifying content that the user has already viewed, or replacing previously viewed content with different content that has not been viewed The exemplary implementation of the MBRW system can provide an Application Programming Interface (API) that permits any authorized software to access RHD from the CSS, whether details of particular user RHD, or abstracted non-personally identifying data, for example Website-related data such as items that users view most often, and whether these are viewed through feeds or on the original Website. The API can be accessed by standard Web programming facilities, such as PHP scripting in Web pages, Perl scripting in CGI scripts, or .NET applications, to provide automatic inclusion of the data in Web pages, to generate reports for Website maintainers, or for other purposes, such as selecting items for inclusion in feeds or “Top 10” lists. Implementation of this method will be familiar to those having ordinary skill in the art. Implementation of this method will be familiar to those having ordinary skill in the art.

Some embodiments use RHD to determine non-personally-identifying aspects of user viewing patterns, such as the frequency with which users view, the average number of items viewed in a session, the most popular Websites, the most popular items, and so on. In some exemplary implementations that include user registrations, additional information can be determined, for example, demographic information concerning users, such as age distribution, sex, geographic distribution or topic interest patterns. Such information can be determined for the viewership as a whole, or can be filtered by time period, by viewership of particular feeds or even of particular items. Such information can be very useful to Website maintainers and other content providers, both to aid in determining what users are interested in, but also in permitting appropriate advertising that will maximize ad revenue. Implementation of this method will be familiar to those having ordinary skill in the art.

To collect RHD from Websites that do not support the MBRW, various methods can be employed. Implementation of this method will be familiar to those having ordinary skill in the art.

RHD can be generated locally in at least three ways: by use of a browser plug-in, by employing cookie-like software similar to spyware or “Web beacons” (small images, often a single pixel, that are embedded in pages, and cause URL references from a Web server when viewed), or by having the capability built into the browser itself. Alternatively, the content Website's server can produce a limited form of RHD, comprising only the pages requested, but not including which items on the Web pages were actually displayed. Implementation of this method will be familiar to those having ordinary skill in the art.

Using the browser plug-in or browser-native capability methods allow RHD to be gathered regardless of the Website visited, and in full detail as to what was displayed, how long it was displayed, scrolling speed, and so on. A system that involves RHD being generated by the Website visited, and thus only considering content from participating Websites, produces more limited RHD coverage as well as more limited data even for covered Websites. Implementation of this method will be familiar to those having ordinary skill in the art.

RHD data can be supplied by systems other than the MBRW or participating Websites. Such RHD can be supplied by Reader applications, or others, as well. Such applications can participate in the system, mimicking the behavior of an MBRW, or have an API through which relevant data can be extracted. It should be noted that if a user of such an application marks an item as “read” without actually viewing the item (a feature of many RSS Readers and widgets such as Plumbb) the items will be considered to have been viewed in the RHD. Implementation of this method will be familiar to those having ordinary skill in the art.

As Reading widgets that can use or support the MBRW system become more common, exchange of RHD can be extended to include these widgets, allowing such widgets to exchange data between themselves and Websites, other Readers or MBRW instances through the CSS. Implementation of this method will be familiar to those having ordinary skill in the art.

By collecting RHD and feed data from several Websites, and sharing information between associated users, a synergy is obtained, where information that would not be available by solo reading of Websites as independent entities can be obtained and used to enhance the reading experience for each user. For example, a priority assigned to each item can be determined based on feedback entered by other users (e.g., a rating system), by noting how many different Websites link to a given item (a link-frequency rating), by noting how many users have viewed a given item (a use-frequency rating), or by categories created by the users in an association to which items are assigned by the associated users or by automated systems using such methods as keywords, context-matching, Website tags, or other techniques. By prioritizing items, and presenting them to the user in priority order, the user is directed to the most important items first, thus making maximum effective use of the users' available time.

### Reader Interest (RI) Data

In some embodiments, the level of interest shown for an item by a user (“Reader Interest” (RI)) is determined using several different factors, such as the length of time the user spent with the item content displayed, how far down a long item the user scrolled and how fast the user scrolled the item. For example, if a user scrolls slowly to the end of a particular item, that is an indication of interest in the item, and potentially interest in items having a high degree of similarity. If the user scrolls rapidly, or scrolls rapidly over most of the item and stops only briefly here or there, this can be interpreted as indicating a lack of interest in the item, and potentially in any item having a high degree of similarity. The fact that the user viewed anything at all in an item indicates at least some interest in the item's topic. Alternatively, or additionally, RI data can be input directly by the user via a numerical rating system (e.g., “five stars”, “rate on a scale of 1-10”, and so on), use of “More” or “Less” icons (similar to the “Thumbs Up/Thumbs Down” rating scheme used by the TiVo video recording service (of Alviso, Calif.) and its devices), or other means as determined to be effective by those having ordinary skill in the art. Implementation of this method will be familiar to those having ordinary skill in the art.

### Importance Data

Complementing RI data, in some embodiments items are also be rated for “importance”. Importance is determined by collecting and analyzing bookmarking, commenting, trackback, viewing frequency and other such data related to an item. The more an item is bookmarked, commented on, linked to, viewed, or otherwise marked and discussed, the more important the item is determined to be. Publicly available (or privately-sourced) data can be collected on all items from any feed or only from those with high RI ratings for a particular user. Data about items originating from sources with different audience sizes can be analyzed relative to their readership. That is, data such as comment count can be adjusted relative to the number of comments typically seen for items from the same source. Implementation of this method will be familiar to those having ordinary skill in the art.

Sources for Importance data such as commenting, trackbacks or reading frequency, can be a standard set of Websites, or they can be Websites specifically chosen by a given user or made up of Websites the user has feeds from, or which the user frequents or bookmarks most often.

Juxtaposing Importance data with RI provides useful information. If an item is deemed to be very important by the community of readers (as determined by Importance data), the RI for the average reader would be expected to be higher than for an item that is not deemed to be important. By comparing a user's RI against Importance data, it can be deduced, for example, that the user is only interested in an item from a particular topic area if the Importance level for that item exceeds a particular threshold. This type of analysis allows for the construction of user-specific Topic Interest Profiles. Such profiles constitute “persistent” metadata characterizing the user's long term interest in specific topics and can be used by the MBRW to select items to present under various circumstances, such as to suggest new feeds or to create lists of items that are likely to be of interest.

### Multiple MBR Widgets

If more than one Website visited by a given user offers support for the MBRW the MBRW can recognize the user by one or more well known techniques, such as a username and password lookup, use of cookies, the network address used by the user's system, or a combination of these or other methods.

In some embodiments, by default users are shown the set of feeds provided by the Website that the instance of the MBRW is associated with (the “current Website”). The MBRW gets user data (feeds, RHD and configuration preferences) from the CSS, obtains feed information from the current Website, filters the feed information to remove already “read” items (unless constructed and arranged not to), tags or otherwise highlights any items that the user or an associate has marked as being of special interest, and presents the appropriate items to the user. Implementation of this method will be familiar to those having ordinary skill in the art.

In some exemplary implementations, the visual presentation of the MBRW is as a small window with tabbed sub-displays each containing a different type of item or feed list, a different subset or ordering of item or feed lists, or a configuration setting display. The default tab (the tab initially selected when the MBRW begins execution) contains items from the feeds of the current Website. This behavior results in the user initially viewing feeds at each Website that are related to the Website. This minimizes distractions (e.g., sports blogs are not presented while perusing a corporate business Website) and helps to keep the feed list in the context of the current blogspace. The MBRW can, however, include a tab that lists feeds from other Websites, and provide the ability to switch to, or include in the current tab, another feed or feeds from other Websites. Such included feeds can be feeds that the user is subscribed to, feeds that the user has viewed on a one-time basis while browsing a Website, feeds that the user specifies by a URL or other such process, or feeds from the RHD of the user's associates. The included feeds can be distinguished from feeds being provided by the current Website in some manner, such as color, font, association with special icons, indents, borders, appearing in a different part of the display, or by other means as will be known to those having ordinary skill in the art. Alternatively, the MBRW can provide a means to switch to a different Website, where a different instance of the MBRW can be started, as is described elsewhere herein. Implementation of this method will be familiar to those having ordinary skill in the art.

While all of a user's feeds can be listed on a single display, in some embodiments, when there are a large number of feeds, or when preferred for any other reason, the list of feeds can be organized as a set of individual displays, linked together in a “chain”, with each MBRW-supporting Website being a separate element in the chain that takes the user from one feed to another in a set order, such as the order that the user encountered the feeds, the order the user accessed the feeds in most recently, sorted by the feeds having the most recently added items appearing first, or last, alphabetically by the title of the Websites the feeds appear in association with, or by any other ordering. Random access to any feed can be effected by various means, such as a dropdown list of available feeds, presentation of a list of links to available feeds, a horizontally scrolling display of visual representations of each feed in the chain, or by other common techniques. Implementation of this method will be familiar to those having ordinary skill in the art.

Regardless of the number of feeds, or the method used select them, all MBRW-related data in the exemplary implementation is stored in the CSS. In the CSS, all feed information for each user is aggregated. If such feeds are designated as public, associates can view the aggregated feed data and peruse the feeds to which the user is subscribed.

### Feed Views

In some embodiments, the MBRW instance provides different views of available feeds, such as feed sources, items (viewed or not yet viewed) by source, the most popular items, the most popular Websites, the most talked about items or Websites, items specially marked by the user or one or more associates, items filtered by date/time or category, lists of associates and their selected feeds, RHD, or other data, and so on. These are described in detail below.

There are several exemplary ways and embodiments by which the MBRW organizes feed items:
1. “Use-Frequency”—by how often the user, or optionally, any associate of the user, views a given feed or feed item within a specified time span.
2. “Link-Frequency”—by how often, within a specified time span, a Website maintainer creates links to each feed or feed item (that is, references the feed or feed item in a feed). Optionally, any set of individual items (potentially originating from different feeds) can be organized according to the same feed metadata.
3. Organize feeds and feed items by category, with a Website maintainer, the user or an associate of the user, assigning feeds or feed items to categories by any common, agreed upon, or arbitrary criteria. Any set of feeds or items can be assigned to the same category or categories that the Website from which they originated were assigned, and such assignment can be done automatically when this is supported and constructed and arranged.

Still other embodiments will be apparent to those having ordinary skill in the art. Implementation of this method will be familiar to those having ordinary skill in the art.

### Items by Source

Listing items by source groups items by the feed that supplied them. Items for each feed can be placed on separate tabs in the MBRW display, on separate sub-tabs of a tab that displays the feed ID information (e.g., the feed's title), included in one large, possibly scrolling, display and delineated from each other in some manner, such as by use of an “outline” form with each feed's items indented from the feed ID information, lines or spacing separating the items of each feed from those of the other feeds, Alternating color bands for each feed, or other techniques as are well known to those of ordinary skill in the art.

Identifying the items included in each feed is a trivial matter, since items originate in feeds, and the association between an item and the feed it belongs to is simply maintained by any storage system, transmission system, or working data structures used in the MBRW or other aspects of the MBRW system.

### Most Popular Items List (“Most Viewed”)

In some embodiments, a Most Popular Items List (MPL) includes items from a user's feeds, where items are rated for popularity based on RI data, optionally adjusted for the feed they originated in, and items with insufficient adjusted RI values are dropped. The remaining items, referred to as the “Quality Pool”, are shown to the user a few at a time in the MPL ordered by adjusted RI. This provides the user with a quick way to locate items from subscribed feeds that have proven to be interesting to other readers of those feeds. It is likely the user will have a higher degree of interest in such items than in items in general. In some exemplary implementations the MPL is updated periodically, such as once a day, once a week or at some other appropriate frequency as designed into the MBRW or set by configuration parameters on a system-by-system, or user-by-user basis. In other exemplary implementations, the MPL is updated each time the user views the MPL. Updates to the MPL do not necessarily result in changes to the items appearing on it. Updating the MPL refers to re-evaluating the MPL content, whether this results in changes to the MPL item content or not. Implementation of this method will be familiar to those having ordinary skill in the art.

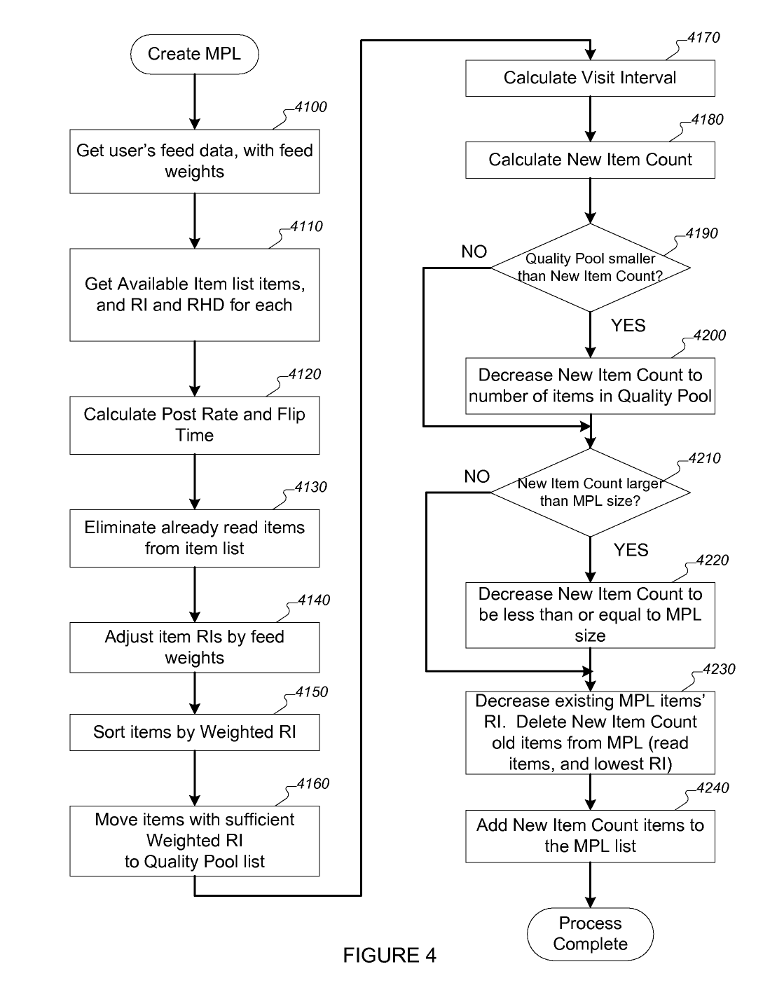

FIG. 4 depicts a flowchart showing an exemplary method for updating an MPL for a user. The process begins by getting a list of the user's feeds and associated feed weight factors (4100). Feed weight factors are optionally assigned by the user to any or all feeds in the user's feed list to indicate the value the user places on items from the feed. For example, feeds that the user considers to be more important, more interesting, or more valuable are given larger weight factors, and those that are less important, less interesting or less valuable are given lower weight factors, or no weight factors. Implementation of this method will be familiar to those having ordinary skill in the art.

The process continues by acquiring item lists from the user's feeds, with RI and RHD for each (4110), that have appeared within a specified time period, such as the preceding 30 days, the prior week, or since the beginning of the year. The time period can be constructed and arranged by the user in some exemplary implementations. In other exemplary implementations the time period is constructed and arranged for all users in the CSS. In still other exemplary implementations the time period is fixed in the implementation and cannot be constructed and arranged. In yet other exemplary implementations there is no time period, and all items for which there is RI/RHD data are considered for the MPL. The item list and associated RI and RHD data can be acquired from the CSS, since items which have no RI/RHD are not of interest for the MPL, so scanning the actual feeds for item data would be less efficient and consume more resources than using the stored data already collected. The item list so created is referred to herein as the Available Item list. Implementation of this method will be familiar to those having ordinary skill in the art.

The next step in the process is to calculate the Post Rate and Flip Time (4120). The Post Rate is the rate at which the user's feeds have acquired new items in a recent time interval, such as the prior 30 days. For example, if the user's feeds acquire 85 new items in a 30-day period, the Post Rate is 19.8 items/week, or 2.83 items/day. The Flip Time is the time required, at the calculated Post Rate, to acquire enough new items to completely fill the MPL. If the MPL displays the “Most Popular 10 items” from the user's feeds, the Flip Time at the example Post Rate of approximately 20 items/week will be 3 days. Exact calculations of Post Rate and Flip Time are not required, and rounding or truncation of fractions is permissible. In actual practice the Post Rate is only an approximate figure based on recent history, and the actual rate at which the user's feeds acquire new items may be higher or lower than the calculated figure. The Post Rate constitutes a reasonable guess at best as to the number of new posts to expect in the immediate future. Implementation of this method will be familiar to those having ordinary skill in the art.

After calculating the Post Rate and Flip Time, the next step is to eliminate items from the Available Item list that the user has already read (4130). Use of RHD makes this process a simple matter for anyone with ordinary skill in the art. The items remaining in the Available Item list include those items from the user's feeds that the user has not already read, optionally comprising only those that appeared within a specified time frame, for which there is RI and RHD data. Implementation of this method will be familiar to those having ordinary skill in the art.

The next step is to calculate adjusted RI values for the items in the Available Item list, using the feed weights assigned to the feeds that the items originated in (4140). This adjustment can involve a simple multiplication of the feed weight by the item's RI value, adding the feed weight to the item's RI value, or some other calculation as deemed reasonable by someone with skill in the art. The resulting adjusted RI value is referred to as a “Weighted RI Value”, and is assigned to the item in the Available Item list in a way that is persistent (that is, that survives for use in the updating the MPL in future) and that makes the “Weighted RI Value” available for use in MPL update calculations, but does not affect other processes. Available Item list items are then sorted by their Weighted RI Values (4150), and the top “Quality Pool Threshold percentage” items are added to a list referred to as the Quality Pool (4160). The Quality Pool Threshold percentage is designed into the system, constructed and arranged for all users, or constructed and arranged individually for each user. For example, if the Quality Pool Threshold percentage is 200%, the top 200% of Available Items, as determined by Weighted RI Values, are added to the Quality Pool. The Quality Pool constitutes the list of items qualified for adding to the MPL. Implementation of this method will be familiar to those having ordinary skill in the art.

Next the Visit Interval is calculated (4170). The Visit Interval is the time span that has elapsed since the user's last use of the MPL. In some exemplary implementations, spans below a certain size are ignored. For example, if a user uses the MPL, and then uses the MPL again 10 minutes later, an exemplary implementation can ignore the second use and view the two uses as a single use occurrence. The minimum time span required for a use to be seen as unique in such exemplary implementations can be designed into the system, set for all users, or set individually for each user. Implementation of this method will be familiar to those having ordinary skill in the art.

The procedure then calculates how many new items (New Item Count) to add to the MPL on this update (4180). The New Item Count calculation involves use of the Flip Time and the Visit Interval using a formula such as the following:

$$NewItemCount = \frac{VisitInterval}{FlipTime}$$

The intent of the calculation is to determine a rate of new item addition that will not exhaust the Quality Pool, while still providing the user with new items on each visit. Since there are variables involved, such as the rate of new items being added to the user's feeds and the frequency with which the user views the MPL, it is possible that the Quality Pool could be exhausted anyway, so a check is made for this situation (4190). If the Quality Pool does not contain sufficient items to meet the calculated New Item Count, the New Item Count is decreased to match the number of items in the Quality Pool (4200). It is also possible that the calculation can result in the New Item Count being larger than the number of items displayed in the MPL, so a check is also made for this situation (4210), and if the New Item Count is larger than the MPL size, the New Item Count is decreased so as to be less than or equal to the MPL size (4220). Whether the New Item Count is reduced to be equal to the MPL, or less than the MPL, is determined by the design of the system, a configuration setting shared by all users, or a configuration setting for each user, or a combination of these options, as determined to be proper by someone with skill in the art. Implementation of this method will be familiar to those having ordinary skill in the art.

Once the number of new items has been determined, space must be made in the MPL to accommodate them by removing previously inserted items from the MPL (4230). Any item that the user has read is removed first. If the number of read items is less than the New Item Count, additional items are removed based on their Weighted RI Values. To ensure that even items with high Weighted RI Values eventually get removed if not read, the Weighted RI Values of all items in the MPL are reduced prior to choosing those with the lowest Weighted RI Values for removal. The longer an item stays in the MPL, the lower its Weighted RI Value will become, and the more likely it will be chosen for removal. Once sufficient space has been created, the number of new items specified by the calculated New Item Count is added to the MPL from the Quality Pool, in order by Weighted RI Values, starting with those having the highest Weighted RI Values (4240). This completes the MPL update procedure. Implementation of this method will be familiar to those having ordinary skill in the art.

Some exemplary implementations support inclusion of a “more” function in the MPL This can be implemented by use of a control, such as a button, in the MPL display or by other means as will be obvious to those of ordinary skill in the art. Some current systems support a “more” capability, but this is different than that described herein. Current systems' “more” capability simply displays additional items from different time periods, or by loosening the requirements to be considered “popular”, or even by simply displaying all available items. They do not retain the concept of “most popular” in their “more” displays. Exemplary embodiments of the invention implement a “more” function in the MPL by performing an update on the MPL as described above. This causes additional items in the Quality Pool to be added to the MPL to replace items that have now been read. The use of Visit Interval data tends to limit addition of new items other than to replace those that have been read due to the short intervals between updates, and this can entirely block new items other than replacements for read items unless the Post Rate is very high, resulting in a short Flip Time. This method maintains the quality standards for items to be included in the MPL list, and thus retains the utility of the MPL while still allowing the user to see more items than the MPL displays at once. Implementation of this method will be familiar to those having ordinary skill in the art.

If the user uses the “more” function at too high a rate, the Quality Pool's quality will begin to degrade, with items having lower and lower Weighted RI Values being included in the Quality Threshold percentage due to the fact that read items are eliminated from consideration early in the process described above. Display of the original, weighted and/or degraded RI values for items in the MPL can permit the user to determine the actual quality ratings of the items included, and assist in deciding whether to continue using the “more” function, or to wait for new items to appear in the feeds that might raise the available quality threshold level. Implementation of this method will be familiar to those having ordinary skill in the art.

### Most Talked About Items List (“Most Buzz”)

In some embodiments, a Most Talked About Items List (MTA) includes items from a user's feeds, where items are rated based on the number of times an item is duplicated on other Websites, the number of feeds that include or link to an item, or a combination of these or other indicators of widespread discussion and distribution of an item. In some exemplary implementations items that are determined to be similar to an item (where similarity is determined as previously described) are considered in such determinations. This provides the user with a quick way to locate items from subscribed feeds that currently or recently have proven to be interesting to several Website owners, or that touch on common topics that are generating interest. It is likely the user will have a higher degree of interest in such items than in items in general. In some exemplary implementations the MTA is updated periodically, such as once a day, once a week or at some other appropriate frequency as designed into the MBRW or set by configuration parameters on a system-by-system, or user-by-user basis. In other exemplary implementations, the MTA is updated each time the user views the MTA. Updates to the MTA do not necessarily result in changes to the items appearing on the MTA. Updating the MTA refers to re-evaluating the MTA content, whether this results in changes to the MTA item content or not. Implementation of this method will be familiar to those having ordinary skill in the art.

In other embodiments, updates to the MTA are performed in a manner analogous to the updating of the MPL, e.g., including use of weighted values based on feed, and optional support for a “more” function. Only the kind of data used to rank items differs, with the MTA making use of item duplication counts, count of appearance of the item in different feeds, or similar indications of widespread interest, rather than the RI/RHD data used for the MPL rankings. Implementation of this method will be familiar to those having ordinary skill in the art.

### Marked Items List

Some embodiments include a Marked Items List that is controlled by the user, the user's associates, or both. This list is made up of items that the users, or user's associates, have explicitly marked for viewing, later recall, or for some other reason, desire to indicate and permit easy separation from the remainder of the items in the user's feeds. Users can use this capability to mark items that they want to view, but can't get to right away, and want to view at their first opportunity, or items that they have viewed, but want to save for later reference and have the item be easy to locate. Associates can use the capability to point out articles for the user to view; that they feel will be of particular interest. Implementation of this method will be familiar to those having ordinary skill in the art.

In other embodiments, items marked by users are indicated in a manner different from those marked by associates. This difference can be indicated in ways well understood by those having ordinary skill in the art, such as by differences in font, text size, color, associated icons, or by displaying the user's marked items separately from those marked by associates (e.g., in different tabs, in different groups on the same tab, and so on). An indication of the identity of the associate, or associates in cases where more than one associate marks the same item, can be provided as well in some exemplary implementations.

### Recommended List

In some embodiments, a Recommended list is provided, which, in more specific embodiments, is controlled by a maintainer of a Website supporting the MBRW, such as a blogger. This allows the Website maintainer to guide users and have some influence over what users view. The feed creator cannot only recommend items from the Websites in the feed creator's feed, but can include items from the feed creator's own Website content in this list where this is considered appropriate. In other embodiments, the MBRW filters the list supplied by the Website maintainer such that the resulting list includes only those recommended items that are from Websites in the user's feed list. This keeps the user within the user's chosen blogspace despite a Website owner's provision of potential interesting distractions. Implementation of this method will be familiar to those having ordinary skill in the art.

Some current Website maintainers have sections of their Websites that provide recommended links. Some are named “recommended items”, others “The best of?”, or other similar labels but they are generally items that the Website maintainer feels will be the most useful to users. The Recommended List of the current invention differs from these however, in that current lists are usually included items from within the Website maintainer's own Website, not from other Websites, and where other Websites are included, these can include Websites that the user is not interested in. The Recommended List in various embodiments of the invention can include the intersection of the Website maintainer's recommended items, and the feeds that the user is currently viewing. This provides an additional benefit when a recommended Website requires a registration procedure. If listed items are restricted to the feeds the user already receives, the user is very likely to be registered for those Websites already, and will not have to spend time doing so to view the items. If the user is directed to a Website where registration is required, but the user is not registered already, the user will either have to spend the time and effort to register, or will not be able to view the item. For a busy user, being directed to such an item is unlikely to be efficient or helpful, and the MBRW's ability to prevent this scenario benefits the efficient use of the user's available time.

According to some embodiments, in constructing the Recommended List, the Website maintainer is provided with three options by the MBRW system:
1. The Website maintainer can periodically create a list of their recommended items. (e.g., every day, week, month, and so on, depending on their preferences).
2. The Website maintainer can permit the MBRW to create the Recommended List for them. The MBRW creates the list by selecting the most popular items from the maintainer's Website, and using these as the Recommended List. The items in this list are different from the user's Most Popular List because the user's MPL includes items from all feeds in the user's feed list, while the MBRW-created Recommended List includes only items from the maintainer's Website.

Still other options and implementation details will be apparent to those having ordinary skill in the art. Implementation of this method will be familiar to those having ordinary skill in the art.

### Feed Filtering

In some embodiments, a user's feeds are filtered, e.g., so that a subset of the items in the feeds the user subscribes to are displayed, whether by MBRW design, constructed and arranged option or by user command. In more specific embodiments, items or feeds that are filtered out are not removed from the user's feed list or item lists; filtering affects the display of the items or feeds by suppressing inclusion in those items or feeds that are shown to the user. In some embodiments, filtering of each item is based on the feed of which the item is a part, the time period in which the item was received, the category to which the feed or the item are assigned, whether the item, or the feed of which the item is part, have been recommended by the current Website owner, the user or an associate of the user, whether the item matches a search specification, whether the item has been viewed or not, or by other requirements. Filtering by importance of the item or feed to the user is an example of such other requirements, and is described below. Implementation of this method will be familiar to those having ordinary skill in the art.

Filtering items or feeds by importance to the user is similar to selection of items based on popularity, as is done for the MPL list, but rather than using a count of references or viewers, Importance data is used to select items or feeds for inclusion or exclusion. Those items or feeds that are sufficiently important are included, the remainder is excluded. Alternatively, items or feeds can be sorted by importance, and presented in order of importance, or only a specified number of the most important items or feeds presented to the user. Implementation of this method will be familiar to those having ordinary skill in the art.

### Blogmaps

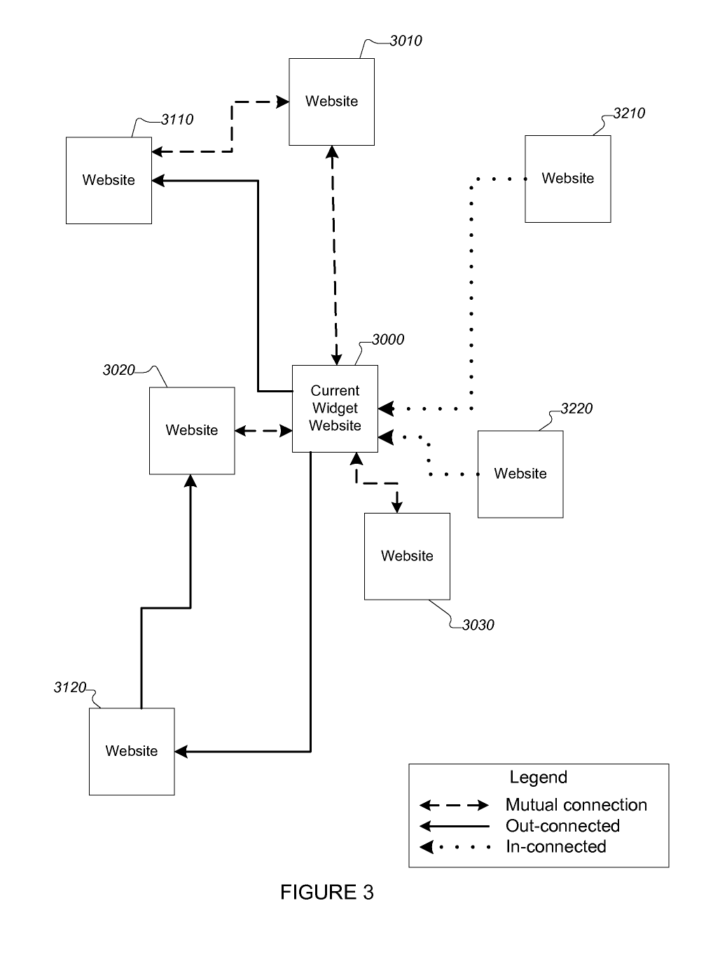

A first Website can often share topical interests with several second Websites, and these second Websites are typically the Websites listed in the first Website's blogroll. Likewise, the second Websites often include the first Website in their blogrolls, as well as listing each other. Those who maintain and use blogs refer to the set of Websites related to a given Website by such blogroll links as the “blogspace” of the first Website. Another capability of the exemplary embodiment of the current invention is the visual representation of the blogspace of a given Website. This representation is referred to as a “blogmap”. As shown in FIG. 3, a blogmap portrays the Websites in the first Website's (300) blogspace along with the links between them, the strength and type of such links (e.g., listed in the blogroll, mentioned in one or more items, and so on), and other useful information related to the relationships between the Websites in the blogspace, such as the number of shared users, update frequency, or other metrics. FIG. 3 depicts Websites that are linked to from the current Website (3110 and 3120), those that link to the current Website (3210 and 3220), and those that both link to, and are linked to by, the current Website (3010, 3020, and 3030). The distance between the Websites in the display represents the strength of the association. For example, Website 3020 is depicted as being closer to the current Website (300) than Website 3010, even though both have mutual links with the current Website (300). This can be due to the relative number of times each Website is linked with the current Website (300), or the types of linkages (e.g., included in a blogroll, linked from an item, and so on). While the terminology used in reference to this capability originates from blogging, similar capabilities, practices and relationships can also exist between non-blog Websites, and embodiments the current invention deals with such Websites in the same manner as it does with blogs. Details of this capability are included below.

In some embodiments, the MBRW provides at least two ways to select Websites for inclusion in a blogmap display:
1. A blogmap created from the Websites listed in the Blogroll of the current, or a user-specified, Website. That is, a “Website-centric blogmap”.
2. A blogmap created from the Websites providing the feeds that the user, or a specified associate, subscribes to. That is, a “user-centric blogmap”.

The general appearance and features of each of these types of blogmap are the same. The blogmaps differ in the way the “central” Website is selected, and in how Websites are selected for inclusion in the display.

Website-centric blogmaps have the selected Website, whether the current Website (the default) or a different Website selected by the user, as the “central” Website. The Websites selected for inclusion in the display are those Websites that are linked to or otherwise referenced by the items on the central Website, such as those items included in the feeds listed in the Website's blogroll.

In some embodiments, the determination of the “central” Website for user-centric blogmaps is based on a feed selected from the list of feeds the user is subscribed to, by the user entering a URL for a Website or feed, by determining which of the feeds or Websites in the user's subscription list the user reads most often, or the feed or Website that provides the greatest number of items, or has the greatest number of links in its blogroll, or by other means as will be apparent to those of ordinary skill in the art. The determination of which particular method is used can be determined by an MBRW configuration setting, or by asking the user to select the method. Websites are included in the blogmap if they appear in the user's feed or Website lists, or if they appear in the blogrolls of any of those Websites. Implementation of this method will be familiar to those having ordinary skill in the art.

In some embodiments, links between Websites are determined by the MBRW system by searching the Websites to discern their blogrolls, or to locate links or other references in the items on the Website, or in the Website's feeds. This technique is not perfect, since there is no standard method of designating a blogroll. Many Websites do not label their list of recommended Websites as a blogroll, but use other terms, or no labeling at all. The searching method involves examination of each Website in detail, looking for a limited set of terms commonly used to describe blogrolls, such as, “My Favorites”, “Blogs to Read”, and so on as well as looking for HTML links to feeds or to other Websites. If a term that might indicate a blogroll is been found, and there are links listed near it that lead to other Websites or feeds, that set of links is considered a blogroll and the list of Websites and/or feeds included in the blogmap. If an isolated link to a Website or feed is found, and that Website or feed is included in one or more feed lists known to the MBRW system, that link is considered to indicate a Website or feed in the blogspace of the Website being searched, and is included in the blogmap for that Website. In more detailed embodiments, the MBRW uses one or more search engine Websites to obtain information about Websites and the relationships between them. Implementation of this method will be familiar to those having ordinary skill in the art.

Similar techniques can be used to determine other metadata about Websites, such as the number of users a Website has, the frequency of updates to the Website, or the average size of an item on the Website, the “reading level” of items on a Website, authors of items on a Website, the average number of links in Website items, average links to Website items from other Websites, the average number of user comments per item, information from public bookmarking Websites, or other such information, and this information can be incorporated into the blogmap. Implementation of this method will be familiar to those having ordinary skill in the art.

The presentation of links between Websites on a blogmap can take a variety of forms. Different colors and line types can be used to represent “incoming”, “outgoing”, and “mutual” links between Websites. The user can specify which types of links should be included in the blogmap display. Websites that are linked to the central Website by incoming, outgoing or mutual links constitute the First Degree of Separation from the central Website. Implementation of this method will be familiar to those having ordinary skill in the art.

Other aspects of Websites, and the relationships between them, can be indicated in the blogmap. For example, the number or type of links between two Websites can be used to determine the distance between the locations of each Website in the display, with more closely related (that is, more links) Websites show as closer to each other than to Websites that have fewer links. Alternatively, the thickness of the line connecting two Websites can be varied based on the strength of the relationship between the Websites. Websites with many items can be show as larger than Websites with fewer items. Websites with more recent items can be shown in a different color or shading than Websites with older items. Implementation of this method will be familiar to those having ordinary skill in the art.

The ability of the MBRW to obtain data about the feeds and items on Websites subscribed to by the user as well as other users, whether in the users associate list or not, by requesting such data from the CSS, permits simple determination of such data for a variety of Websites. It is not necessary for the MBRW to search all of the Websites in the blogmap directly, and due to the security limitations of some exemplary implementation techniques, this may not even be possible.

In some exemplary implementations, the blogmap display includes animation, with the positions and other aspects of the Websites depicted shifting as the user selects different “central” Websites, or as additional information becomes available about the Websites being shown. Such displays are in current use for other purposes, such as the visual mapping tool used on the CNET Website (www.news.com), which shows the relationships between content items on that Website. The technology used by CNET for this purpose is Liveplasma (www.liveplasma.com, by frederic.vavrille@liveplasma.com of Paris, France). The Website http://www.literature-map.com/ shows the relationship between the works of various authors using a similar technique, with the distance between a selected author and those “near’ that author in style or other factors, showing the closeness or remoteness of the relationship. Implementation of this method will be familiar to those having ordinary skill in the art.

In some embodiments, blogmaps have a third dimension that represents importance, authority, or any other attribute. For example, those Websites with greater authority can be represented as “nearer” the user, and those with less authority as “farther away”. “Authority” can be measured by how many Websites link to a particular Website. Websites that are linked to frequently are more authoritative than Websites that are not linked to as much. In considering such link counts, specific periods of time, such as the previous month, six months, or year can be used, to limit the influence of spikes in linking activity that can occur at times. Blogmaps can depict a third dimension using a standard graphical representation that simulates the third dimension with visual clues, such as size, overlap, color, contrast, perspective, or other well-understood methods, even though they may be using a two-dimensional computer display. Implementation of this method will be familiar to those having ordinary skill in the art.

In still other embodiments, blogmaps show how Websites that link to the central Websites also link to each other. Such links can be shown continuously, or only when requested. For example, if the user hovers a pointing device cursor over a linked Website, the links between that Website and the other displayed Websites appear, but are otherwise not shown. Display of secondary links only when requested can help to reduce “visual clutter” and make it easier for a user to see the information of interest. Alternatively, the user can request that all links be shown at once, or some subset, such as all incoming links, all mutual links, and so on. Metadata related to depicted Websites and their links can also be displayed, whether in a scrolling display separate from the blogmap, in the blogmap when the user “hovers” over a Website, or by other means well understood by those of ordinary skill in the art. Implementation of this method will be familiar to those having ordinary skill in the art.

Using the search and user data in the CSS, blogmaps can be produced for any Website. In some embodiments, the MBRW accesses the CSS database and designate any Website as the central system. In the blogmap display, the user can designate a new central system Website, and the MBRW creates a new blogmap with the designated system as the central system. In this way a user can move around visually in a given blogspace, seeing the relationships between various Websites. In some exemplary implementations, the user can subscribe to feeds from depicted Websites by indicating which feeds are of interest, such as by clicking a pointing device, such as a mouse, trackball or light pen, on them. Implementation of this method will be familiar to those having ordinary skill in the art.

In addition to the visual representation of blogmap data, in some embodiments the MBRW displays the same information in graph form, tabular form (BlogCharts), or other standard methods of displaying data sets. The form used is constructed and arranged by the user, which permits the user to select the form most applicable to the user's capabilities (e.g., blind users may find that BlogCharts are more compatible with their reader software than blogmaps are). Implementation of this method will be familiar to those having ordinary skill in the art.

Blogmaps and BlogCharts can be very useful to both users and Website maintainers. For Website maintainers Blogmaps and BlogCharts provide a means to help understand how their Website fits into the current blogosphere and determine the Websites with which they have linking relationships. Website maintainers can use such information in constructing blogrolls. Users can use blogmaps when first starting to explore a blogspace to determine Websites of interest within that blogspace. Currently that process tends to be haphazard. A blogmap or BlogChart can help the user quickly identify the Websites in a blogspace, determine their popularity, relative authority, activity level, and other aspects of interest. Blogrolls alone do not provide this level of information, and are based on the views of the Website maintainer that creates them, while blogmaps/BlogCharts include information which is derived from the preferences and actions of many Website maintainers and other users. Implementation of this method will be familiar to those having ordinary skill in the art.

In some exemplary implementations, users can specify any Website included in a blogmap or BlogChart and add the blogmap or BlogChart to their Website list, or have the feeds available on that Website added to their feed list. The MBRW can also provide a means to construct an OPML file of feeds that can be exported to a Reader. Feed URLs can be provided for direct insertion into URL input fields of Readers as well. Implementation of this method will be familiar to those having ordinary skill in the art.

### Associations

In some embodiments, the MBRW System provides the capability for users to designate one or more other users as “associates”. A first user can have several disjoint or overlapping groups of associates, a single group of associates, or no associates. Designation of a second user as an associate gives the second user the ability to share feed subscription information or feed data with the first user, tag, prioritize or otherwise mark the first user's feeds or feed items, and to view the first user's RHD. Details of these capabilities are provided below. Implementation of this method will be familiar to those having ordinary skill in the art.

### Group Reading and Ratings

In some embodiments, using the MBRW, associates make some or all of their RHD available to each other. With this feature enabled, a user can see whether an associate has viewed a specific item. This can be displayed, e.g., as a tab in the MBRW that lists all the items that show up on the user's or the associate's list of items to view. In alternative embodiments, there is a composite tab combining the data for all associates, or one tab per associate, or one tab per group of associates. In other alternate embodiments, the associate's RHD information is included in the item lists that are shown for the user. Implementation of this method will be familiar to those having ordinary skill in the art.

With a small group of associates, the metadata representing which associate has viewed each item is displayed by way of icons, each representing an associate, that is placed near a item's listing or content if a item has been viewed by that associate. Alternatively, an icon can be placed near an item's listing or content if the item has not been viewed. Implementation of this method will be familiar to those having ordinary skill in the art.

RHD for association members can be used in several ways. In one embodiment, if a group of associates is concerned with several feeds and it is determined to be advantageous to reduce the amount of time group members as a whole spend viewing the feeds, then knowing that an associate has viewed a particular item saves the remaining associates from having to spend time viewing the item. In this scenario the system would automatically tag or suppress display of the items previously viewed by any associate in the group from the user's list of items to be viewed, or cause such items to be marked as “read”. In the latter case, the indication used to mark an item as “read” is made distinct from the indication used when the user has viewed the item personally. Implementation of this method will be familiar to those having ordinary skill in the art.

In other scenarios, it can be advantageous to ensure that all associates in a group view an item. Indicating, such as by the presence of special icons, fonts, colors, or otherwise, those items that remain un-viewed by the user or other associates, serves as an incentive to view the items since all associates are being kept aware of who is behind in viewing an item. As an aid to locating items that are “group read” items, in some embodiments an indication of that status can be included for the item in the user's list of items. Such indication can be an icon located near the item or its content, use of color, font, size, or other visual difference, or other indications as well known to those with skill in the art. Alternatively, or additionally, such “group-read” items can be moved to the top of the item list or to some other prominent location, such as a list consisting only of such items. Implementation of this method will be familiar to those having ordinary skill in the art.

Some exemplary embodiments of the current invention include a capability for associates to flag important items for special attention. For instance, if an associate views an item that is particularly pertinent or important, the item can be marked with an indication that the item should be viewed as soon as possible by another associate. Such indication can be an icon located near the item or the item's content, use of color, font, size, or other visual difference, be placed in a special location (e.g., the top of the item list or a separate list reserved for such items), or by use of other indications as are well known to those with skill in the art. In some exemplary embodiments, the priority assigned to such items, and/or the method of indicating the items, can be adjusted based on the number of associates who specify that the item should be viewed by the user. Implementation of this method will be familiar to those having ordinary skill in the art.

In some cases an article of interest will not be included in the viewing lists of all associates, but only in a first user's viewing list, or in the viewing list of a subset of associates. In this case, specifying that the article should be viewed by any or all associates will cause the article to be added to the viewing lists of the associates specified. For example, if an associate is viewing the blog “ReadWriteWeb”, but the user is not, and the associate finds an interesting item in the blog, the associate can specify that the item is to be a “group-read” item. This results in the item being added to the item list of all associates in the group. The user can configure how such suggested group-read content items appear, such as in a special feed, in a list of recommended items, in a special tab within the MBRW, in conjunction with an icon indicating that status, or marked by color, font, font size, or in some other manner as will be known by those having ordinary skill in the art. In addition to this, E-mail, Instant Messages, or SMS text messages also can be generated and sent to notify the user of the associate's addition to the user's viewing list. Implementation of this method will be familiar to those having ordinary skill in the art.

In some embodiments, the MBRW includes a rating system for individual items. Users can rate items and have the ratings made available through the MBRW for associates. The rating system can be a simple linear rating, such as the five-star rating system offered by Spotback (www.spotback.com, owned by Spotback Ltd. of Hamerkaz, Israel), or a more flexible system that allows users to rate items using two or more dimensions. That is, several users viewing a company blog, for example, can form an association and create three dimensions by which to rate the corporate postings, such as “relevance to sales”, “degree to which follow-up is needed”, and a rating for “time-sensitive vs. evergreen information”. Another group of users, some of whom can be members of the association viewing the company blog, can form a different association and create a four dimensional rating system to use for rating blogs having to do with video entertainment. Such a rating system might include dimensions such as “humor level”, “quality of acting”, “quality of cinematography”, and “likelihood of buying the DVD”. Such multi-dimensional ratings can be expressed via small icons beside individual items, sliding scales, named ratings (e.g., “High”, “Medium”, “Low”) or by other means as will be apparent to those having ordinary skill in the art. Assigning such ratings is similar to tagging items to convey additional metadata about the items. A tagging system, however, has no means to weight a tag to vary the import in a particular case, and allows for an ever-increasing number of tags as users decide on different nuances of meaning for each item. A common result is that users never use the same measurement criteria when they consider items and the tagging system loses utility. The MBRW rating system, on the other hand, enables groups of users to construct their own language with which to describe and measure item qualities, and then supports use of the language while inhibiting item-by-item alterations to the system to increase overall utility. Implementation of this method will be familiar to those having ordinary skill in the art.

In addition to multi-dimensional ratings, in some embodiments the MBRW provides composite ratings. In more specific embodiments, the composite ratings are constructed from individual ratings, whether of single or multiple dimensions, by averaging them. Hovering over a composite rating, or performing some other typical action to indicate interest in details of the composite rating, shows how each user rated the item. The system permits diverse users to have differing weights in calculating the composite rating, so that some user's ratings count more than others in the final composite rating result. The range of such ratings can be expressed as a bar laid over a scale of the available ratings, with the average point, or the weighted average point, denoted visually, or by other means. Implementation of this method will be familiar to those having ordinary skill in the art.

### List Associates

In some embodiments, the MBRW includes a capability to permit users to list their associates. Associates can be listed in a number of different ways, such as alphabetically by name, by date added to the user's association list, by the group(s) they belong to, by date of last RHD entry, or by any other sorting or grouping scheme determined to be useful by those having ordinary skill in the art. In more specific embodiments, the list of associates can be used to remove associates from further association with the user. In some exemplary implementations a user right-clicks on an associate to bring up a menu of options. The menu of options includes selections for deleting the associate from further association, deleting the associate from one or more associate groups, adding or removing access to the user's RHD or feeds, and so on. Implementation of this method will be familiar to those having ordinary skill in the art.

### List Associates' Feeds

In some embodiments, where an associate has granted permission, a user can use the MBRW to obtain a list of feeds subscribed to by the associate. In some exemplary implementations, the user can subscribe to a feed that is part of such a list by means such as right-clicking a feed in the associate's feed list and choosing “subscribe” from the pop-up menu. Implementation of this method will be familiar to those having ordinary skill in the art.

### List Associates' RHD

In some embodiments, where an associate has granted permission, a user can use the MBRW to view the associate's RHD. Such a list can be in a “raw” form, which just lists items, flags which items have been viewed or not viewed and the date and time the items were viewed. Such a list can be in a more organized form, in which items are grouped by feed or date/time, or filtered to include only those items the user is interested in RHD for. Filtering can involve use of wildcards to specify items, dates/times, feeds or other related characteristics of the RHD entries. Implementation of this method will be familiar to those having ordinary skill in the art.

### Catchup and Read Later

Some embodiments include a CatchUp feature that uses the RHD for a user to permit the user to filter a displayed Web page such that only those items which have not been viewed by that user are displayed. In some exemplary implementations, a CatchUp icon appears on the Web page itself or in the MBRW. When the user clicks the icon, the displayed page is re-constructed and arranged to show only those items that have not been viewed by the user. All items marked as “read” in the RHD for the user are suppressed and not displayed, leaving only the un-viewed items. This feature is particularly useful when the items on the page appear in chronological order, as is common with blogs. When items are added to the page over time, and a user views the page only intermittently and with insufficient time on each visit to view all of the items added since the last visit, there can be “islands” of un-viewed items amid the groups of those which have been viewed, and the CatchUp feature is particularly useful for permitting the user to find and view the older un-viewed items in such a scenario. This method of allowing users to view un-viewed items is markedly different from typical Reader methodology. With a Reader approach, the user is given a list of items to view and is required to carefully make each selection. When some items have been viewed previously, and some have not, the user must select each un-viewed item manually. The CatchUp method permits the user to create a customized list containing only those items which are u-unviewed by that user, and avoid having to select them individually. Moreover, this list can be in the context of the actual Web page the items appear on, not just in a Reader's item index listing. Implementation of this method will be familiar to those having ordinary skill in the art.

In some embodiments, a user can configure the MBRW to always view Web pages in CatchUp mode, thus eliminating the need to wade through items they have already seen to locate un-viewed items. In some exemplary embodiments, a control, such as a button, is provided to disable the CatchUp feature temporarily. Complementing this functionality, another configuration setting and/or control allows for the presentation of items that have been previously viewed. This capability is useful when the user is looking for something already viewed, for example, to show it to a second user. Yet another configuration and/or control permits the restoration of viewing of all items, viewed and un-viewed. Implementation of this method will be familiar to those having ordinary skill in the art.

When it is possible to determine the date or time that each item appeared on a given Web page, in some embodiments the CatchUp capability permits limiting displayed items to those that appeared prior to a given date or time, since a given date or time, or during a particular time period. Implementation of this method will be familiar to those having ordinary skill in the art.

In a manner similar to the CatchUp functionality described above, in some embodiments the MBRW also permits presentation of the items on a Web page that have been marked “Read Later” by the user. Items are designated to be viewed later via an icon that is placed in conjunction with each item displayed, whether in an MBRW listing or on the display of the original Web page of the item. Implementation of this method will be familiar to those having ordinary skill in the art.

In some embodiments, when it is not possible to re-render the displayed Web page in the manner required to show items in CatchUp mode or Read Later mode, the text of the items is made into entries for a synthetic feed, and a page layout for display of the items in a Web page context is selected or created. For example, if the Web page is a blog, a blog-like page layout is selected from a library of page templates, or a layout compatible with a blog is generated by the MBRW so that the items can be displayed in a Web page context if the user requests this, just as if the original Web page they are derived from could have been re-rendered as needed. Implementation of this method will be familiar to those having ordinary skill in the art.

In some embodiments, users viewing feeds via MBRW for Websites that do not have the MBRW installed record the item as a “read later” item; this action places that particular item into a synthetic feed, which is accessed and browsed like any other feed using the MBRW. The user has the option of having such items deleted from their original feed, and only appearing in the synthetic feed, or the user can keep both references to the item extant. In the latter case, when one instance is marked viewed, they are both marked as viewed, just as if the same item had appeared in two non-synthetic feeds. Implementation of this method will be familiar to those having ordinary skill in the art.

### The Have-Read Recycle Capability (HRRC)

When a user views an item, it may be advantageous to re-read, review, or reconsider similar material viewed in the past. Such repetitive activities can serve to reinforce the learning of key points that may be present in both items. The Sphere Related Content Widget (made by Sphere Source, Inc. of San Francisco Calif.) addresses this by presenting additional posts about the post being viewed (which may or may not have been viewed), while BlogRovr (made by Persefon Ventures of Palo Alto, Calif.) offers similar posts from feeds favored by the user, but which have not yet been viewed. The Have-Read Recycle Capability (HRRC), rather than finding new items on similar topics from familiar sources, focuses on reinforcing what has already been seen and perhaps only partially retained by the user in items that have already been viewed.

In some embodiments, the MBRW keeps data about what each user has viewed. The MBRW adds metadata, such as similarity data that enables identification of items similar to those that the user has viewed. This data can be used to enhance a user's experience by presenting items to the user that have previously been viewed that are similar to an item currently being viewed. This is referred to herein as the “Have-Read Recycle Capability” (HRRC). Such presentation can include display of links to items, display of actual items or display of the Web pages the items are derived from. Some indication of the aspects of similarity (overlapping tags for instance) could also be displayed to make users aware of the aspects of overlap that resulted in the older item being selected for inclusion. Regardless of the method used, the user is enabled to quickly compare the current item with past items that are similar to the current item, or to review the previously viewed items in light of what has been learned from the new item. Implementation of this method will be familiar to those having ordinary skill in the art.

The HRRC can be implemented within the MBRW. Alternatively, the HRRC can be implemented by processes on the CSS, or elsewhere, in conjunction with the MBRW. The HRRC can be invoked by a control, such as a button, be controlled by a configuration setting, or both. It can optionally be persistently present as part of the MBRW display. The preferred implementation is for the posts and information presented by the HRRC to be juxtaposed in the user's display to the item being viewed so the user can see both at once.

In scenarios where display space is limited, or other factors inhibit display of all similar previously viewed items, selection of the items to include can be made based on factors, singly or in combination, such as “popularity”, most recently viewed, level of similarity, number of times viewed by the user, and so on. The user's RI data can also be used as a factor in selecting previously viewed items, so that items related to topics of the most interest to the user are more likely to be selected by the HRRC. A random component can be used as well, particularly when there are numerous items to choose from.

### Use of Reading History Data by Websites

In some embodiments, Websites that are aware of RHD and capable of interacting with the CSS, make use of RHD data in at least three ways:
1. For personalizing navigation tools.
2. For customizing item content.
3. For personalizing page layout.

### Navigation Tools

In some embodiments, a Website uses RHD to make its Top Ten lists (and other directional widgets and features) specific to a user based on Similarity data and RI data as well as RHD. For example, a Website could create a Top Ten Items list that does not include any items that the user has already viewed, which will maximize the chance that the user will view the items in the list. Use of RI and Similarity data can permit the Website to select items for the Top Ten List that deal with topics of demonstrated interest to the particular user. Implementation of this method will be familiar to those having ordinary skill in the art.

In addition to customizing Top Ten lists, other aspects can be adjusted to personalize the Website, such as sidebars that expand on the subject matter of a main item. Sidebars can be changed to match the topical interests of a particular user. For example, if a main item is a story about a bill in Congress having to do with allocation of funds for research on alternative fuels, a sidebar for a user with a history of technological topic interest might include links and additional items about alternative fuel research, while a sidebar for a user with a history of political topic interest might include links and additional items about the bill's passage through Congressional committees, voting records of various legislators with respect to alternative fuels. Both sidebars might include items concerning the bill's chances of passage. Implementation of this method will be familiar to those having ordinary skill in the art.

In some embodiments, a Website uses RI data to make educated guesses about what topics are of interest to its users and which stories or subject matter it should concentrate on when introducing new material to the Website. In addition, certain items could be purged from Top Ten presentations, while others could be promoted if it appears that user interest has not yet been satisfied based on RI information on that story line. Implementation of this method will be familiar to those having ordinary skill in the art.

### Customizing Item Content

In some embodiments, a Website supports different versions of the same item and present the version that matches a user's preferred reading level, item length, or that most complements an item viewed by the user on another Website. For example, the original item can be “marked up” in various ways to construct alternative item compositions that reflect a Website's unique slant, or a shorter version of the item can be constructed. Such modified items also can have a button to indicate they have been customized, and to allow the user to view the article in its original form. Implementation of this method will be familiar to those having ordinary skill in the art.

### Personalizing the Page Layout

In some embodiments, RHD, Similarity data and RI data are used to influence the layout of a Website to customize it for a particular user. A primary benefit is to reduce or eliminate redundant, or largely-redundant (based on Similarity data) items, and substitute new ones (if available) in their place. Content items that the RI data indicate are likely to be of greatest interest can be highlighted by placing such content items in prime locations or increasing the size of the summaries. A combination of substituting content and rearranging the presentation is done with the goal of enticing the user to view as many items as possible. Implementation of this method will be familiar to those having ordinary skill in the art.

Another use for personalizing page layout is to meet the special needs of readers through such means as using large type for those with vision impairments, omitting audio media for deaf users, or avoiding flashing displays for those with epilepsy. Adjusting for user screen size or resolution, network bandwidth, or processing power are other aspects of page layout that can be improved by customizing for the needs and capabilities of a particular user. The user's needs can be input directly to the RHD system as configuration data, or can be determined deductively through analysis of the Websites they visit most frequently. For example, if a user's most frequent Websites are all Websites catering to deaf people; it is likely that the user is deaf or has a hearing impairment. If the user has a low RI on Websites with small type, even when those Websites cover topics that the user has a demonstrated interest in based on RHD, it may be possible that the user has a vision impairment, or an equipment limitation, that makes small type problematic, and larger type faces should be used in laying out a page for that user.

The Tear-Away Model-Drag and Drop from Anywhere

The exemplary MBRW is a widget that combines a content filtering capability with a Reader that is configurable by the user. MBRW is placed on Websites for download to users. When the user navigates away from the Website, however, access to this navigational tool ends.

A “Tear-Away” version of the MBRW mitigates this problem. It allows a user to instantiate the MBRW and to “take the MBRW with them” as the user browses to other Websites. That is, the user can enter a personalized mode whereby that instance of MBRW is made into a browser tool. Such a browser tool allows the user to call up this instance of MBRW when browsing anywhere on the Web. It then appears as a pop-up window on the current webpage, even without the current webpage having any support for the MBRW system or widget.

In some embodiments, the CSS maintains information about all of the instances of the MBRW that a user has registered, and this information can be accessed and displayed. The MBRW instances can be displayed as individual widgets or combined into a Reader. At the CSS the user can also create and manage additional instances of Tear-Away MBRWs. Implementation of this method will be familiar to those having ordinary skill in the art.

### MBRW-Based Websites

In some embodiments, a Website includes an MBRW instance that provides customized content feeds to a user. Often, this Website is supported by advertising that is rotated each time a page view is redrawn. Thus, it is advantageous for such Websites to maintain a user's attention as long as possible, and to keep then paging thru numerous articles without leaving the initial Website. The MBRW provides a process to this end, in which content items highly customized to an individual user are displayed, and content items that may cause the user to lose interest and move their attention elsewhere are suppressed. Each display is provided as part of a new page view, along with a new set of displayed advertisements. Implementation of this method will be familiar to those having ordinary skill in the art.

The MBRW furthers the Websites goals of maximizing page views by displaying each piece of content in-line (as part of the current Web page) instead of creating a separate window, or even worse, taking the user to another Website. Each of the described features of the MBRW combined to effect the desired goal, e.g., the user reads numerous pages of content items within successive page views on the MBRW Website, thereby maximizing the number of advertisements displayed (and commissions earned from their display).

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

What is claimed is:

1. A method for providing information from at least one data feed to a user, the method comprising:
obtaining at least one putative feed, the putative feed comprising content;
confirming that the putative feed is a valid feed;
extracting at least a portion of content from the feed, the content comprising:
processing the extracted content to produce a synthetic feed; and
presenting the synthetic feed to the user.

2. The method of claim 1, wherein the at least one putative feed is selected from the group consisting of: RSS feeds and Web syndication feeds.

3. The method of claim 2, wherein the at least a portion of content is selected from the group consisting of: blog posts, podcasts, videos, and Web pages.

4. The method of claim 3, wherein the step of confirming the at least one putative feed is performed by determining that the feed is associated with a feed-specific URL.

5. The method of claim 4, wherein the step of confirming the at least one putative feed is performed by determining that the feed includes at least one tag string.

6. The method of claim 5, wherein the step of confirming is performed by scanning the feed for data patterns associated with feeds.

7. The method of claim 6, wherein the scanning includes applying artificial intelligence to identify the patterns.

8. The method of claim 1, wherein the step of processing the extracted content comprises identifying putative duplicate feeds.

9. The method of claim 7, wherein the step of processing the extracted content comprises identifying putative similar feeds.

10. The method of claim 1, wherein the step of processing the extracted content comprises identifying putative similar feeds.

11. The method of claim 1, wherein the step of processing the extracted content comprises identifying putative equivalent content.

12. The method of claim 1, wherein the step of processing the extracted content comprises compiling and storing Reading History Data and Reader Interest Data.

13. The method of claim 10, wherein the step of processing the extracted content comprises using at least one of the Reading History Data and the Reader Interest Data to compile the synthetic feed.

14. The method of claim 1 further comprising obtaining and displaying data related to the content of the feed.

15. A system for providing information from one or more data feeds to a user, comprising:
a communications process constructed and arranged to obtain at least one putative feed;
a confirmation process in electronic communication with the communications process; the confirmation process constructed and arranged to confirm that the putative feed is a feed;
an extraction process in electronic communication with the communications process and the confirmation process; the extraction process constructed and arranged to extract at least a portion of content from the feed or data related to the content from the feed;
a producing process in electronic communication with the extraction process; the producing process constructed and arranged to process the extracted content or the data to produce a synthetic feed; and
a presentation process in electronic communication with the producing process; the presentation process constructed and arranged to present the synthetic feed to the user.

16. The system of claim 14, wherein the communications process is constructed and arranged to receive at least one putative feed is selected from the group consisting of: RSS feeds and Web syndication feeds.

17. The system of claim 15, wherein the portion of the content or data related to the content is selected from the group consisting of: blog posts, podcasts, videos, and Web pages.

18. The system of claim 14, wherein the confirmation process is constructed and arranged to scan the putative feed for data patterns associated with feeds.

19. The system of claim 14, further comprising a compiling and storing process constructed and arranged to compile and store Reading History Data and Reader Interest Data.

20. A computer readable medium containing computer readable program control devices thereon, the computer readable program control devices being constructed and arranged to enable a computer to provide information from one or more data feeds to a user, comprising:
instructions constructed and arranged to enable the computer to obtain at least one putative feed;
instructions constructed and arranged to enable the computer to obtain confirm that the putative feed is a feed;
instructions constructed and arranged to enable the computer to extract at least a portion of content from the feed or data related to the content from the feed;
instructions constructed and arranged to enable the computer to process the extracted content or the data to produce a synthetic feed; and
instructions constructed and arranged to enable the computer to present the synthetic feed to the user.
